(19) United States
(12) Patent Application Publication
(10) Pub. No.: US 2012/0221813 A1
(43) Pub. Date: Aug. 30, 2012

(54) STORAGE APPARATUS AND METHOD OF CONTROLLING THE SAME

(75) Inventor: Naoki Inoue, Odawara (JP)

(73) Assignee: Hitachi, Ltd.

(21) Appl. No.: 13/063,183

(22) PCT Filed: Feb. 28, 2011
(86) PCT No.: PCT/JP2011/001148

§ 371 Date: Mar. 9, 2011

(51) Int. Cl. G06F 12/16

(52) U.S. Cl. 711/162; 711/E12.103

(57) ABSTRACT

The present invention enables efficient redundancy management of control information (data) while suppressing an influence on the storage apparatus. In the storage apparatus 10 which redundantly stores control information in both the first SM 144 (the first memory) and the second SM (the second memory) in response to processing for a data input/output request, in order to cause the second SM 144 to store the same information as the control information stored in the first SM 144, the second MP 122 makes a second DMA 124 (a data transfer device) transfer data with designation of a first transfer range which is a storage region of the control information in the first SM 144. When the control information stored in the first transfer range is updated during the execution of the data transfer, the second MP 122 makes the second DMA 124 transfer data in the first transfer range again with the second DMA 124 given designation of the second transfer ranges created by dividing the first transfer range.

### TECHNICAL FIELD

The present invention relates to a storage apparatus and a method of controlling the storage apparatus.

### BACKGROUND ART

Patent Literature (PTL) 1 discloses a dual memory controller in which a processor stores the same data in two or more memories. The dual memory controller includes: first address registers which respectively latch read addresses of the two or more memories from the processor; second address registers which respectively latch write addresses to the two or more memories from the processor; a comparison unit which compares the address latched by one of the second address registers with the address latched by the corresponding one of the first address registers; and a unit which prohibits the processor from storing data in the two or more memories while copying data stored in one of the two or more memories to the other memory is under process even when the comparison unit determines that the addresses latched by the first address register and the second address register are identical to each other.

Patent Literature (PTL) 2 discloses a disk array device including: a channel adapter; a data disk drive; a spare disk drive which is provided as a spare of the data disk drive; a disk adapter; a cache memory; a control memory; a backup storage unit which is provided separately from the spare disk drive; a first controller which is provided in the disk adapter and copies data stored in the data disk drive through the cache memory to the spare disk drive; a second controller which is provided in the disk adapter, and executes a write request on the backup storage unit in response to the access request made from an upper device while the first controller is copying; and a third controller which reflects the data, written in the backup storage unit by the second controller, in the data disk drive and the spare disk drive once the first controller finishes the copying.

### CITATION LIST

### Patent Literature

PTL 1: Japanese Patent Application Laid-open Publication No. 6-119253
PTL 2: Japanese Patent Application Laid-open Publication No. 2005-157739

### SUMMARY OF INVENTION

### Technical Problem

In PTL 1, in order to store same data in the two or more memories, the processor is prohibited from storing data in the memories while copying of data stored in one of the memories to the other memory is under process. However, if data update is suppressed in this manner, the process is kept in a stand-by state during that period, which affects the performance of the apparatus.

In PTL 2, in data redundancy management, a write request is executed on the backup storage unit in response to the access request made from an upper device during copying, and the data written in the backup storage unit is reflected in the spare disk drive once the copying is finished. However, in this case, the dual processing is repeatedly performed if a write request is repeatedly transmitted from the upper device. This affects the performance of the disk array device, and reduces the security and integrity of data during that period.

The present invention has been made in view of such foregoing backgrounds and aims to provide a storage apparatus and a method of controlling the storage apparatus which enable efficient data redundancy management with influence on the storage apparatus suppressed.

### Solution to Problem

An aspect of the present invention for achieving the above aim is a storage apparatus including: a processor that performs processing regarding data input/output to/from a storage device in response to a data input/output request transmitted from an external device; a plurality of memories that store control information being information used when performing the processing for the data input/output request; and a data transfer device that transfers data in a designated transfer range between the memories, wherein the storage apparatus redundantly stores, the control information, in both a first one of the memories and a second one of the memories in response to a processing regarding the data input/output request, makes the data transfer device transfer data by designating a first transfer range which is a storage region of the control information in the first memory, in order for the second memory to store the same control information as the control information stored in the first memory, and makes the data transfer device transfer again data for the first transfer range, by designating a second transfer range which is created by dividing the first transfer range, when the control information stored in the first transfer range is updated during the data transfer.

Other problems disclosed in the present application and the solutions thereof will become apparent from the description in the Description of Embodiments, the description of the drawings, and the like.

### Advantageous Effects of Invention

According to the present invention, efficient data redundancy management with influence on storage apparatuses suppressed can be performed.

### BRIEF DESCRIPTION OF DRAWINGS

FIG. 1 is a diagram showing a schematic configuration of an information processing system 1.

FIG. 2 is a diagram showing a hardware configuration of a host computer 3.

FIG. 3 is a diagram showing a hardware configuration of a storage apparatus 10.

FIG. 4 is a diagram showing a hardware configuration of a FEPK 11.

FIG. 5 is a diagram showing a hardware configuration of a MPPK 12.

FIG. 6 is a diagram showing a hardware configuration of a BEPK 13.

FIG. 7 is a diagram showing a hardware configuration of a MainPK 14.

FIG. 8 is a diagram showing main functions included in a storage apparatus 10.

FIG. 9 is flowchart for illustrating data write processing S900.

FIG. 10 is flowchart for illustrating data read processing S900.

FIG. 11 is a diagram showing an example of a pair management table (local) 851 used by a replication management function.

FIG. 12 is a diagram showing an example of a pair management table (remote) 861 used by a remote replication function.

FIG. 13 is LU management information 871 which is shown as an example of configuration information managed by the storage apparatus 10.

FIG. 14 shows examples of a data write request 1400 and a data read request 1450 which are transmitted from the host computer 3 to the storage apparatus 10.

FIG. 15 is a view showing a part of components of the storage apparatus 10 which contributes in implementing a redundancy management function.

FIG. 16 is a flowchart for illustrating redundancy management processing S1600.

FIG. 17 is a flowchart for illustrating failure processing S1700.

FIG. 18 is a flowchart for illustrating failure recovery processing S1800.

FIG. 19 is a flowchart for illustrating transfer re-execution processing S1900.

FIG. 20 is a flowchart for illustrating transfer re-execution processing S1900.

FIG. 21 is a flowchart for illustrating transfer re-execution processing S1900.

FIG. 22 is a view showing an example of a transfer range management table 2200.

FIG. 23 is a view showing an example of the transfer range management table 2200.

FIG. 24 is a view showing an example of an information management table 2400.

FIG. 25 is a view showing an example of setting transfer ranges according to a first setting method.

FIG. 26 is a view showing an example of setting transfer ranges according to a second setting method.

FIG. 27 is a view showing an example of setting criteria of transfer ranges according to the second setting method.

FIG. 28 is a flowchart for illustrating transfer range dynamic change processing S2800.

FIG. 29 is a view showing an example of a method of dividing the transfer range.

### DESCRIPTION OF EMBODIMENTS

An embodiment is described below with reference to the drawings.

FIG. 1 shows a schematic configuration of an information processing system 1 described as an embodiment. As shown in FIG. 1, the information processing system 1 is configured to include at least one host computer 3 (an external device) and at least one storage apparatus 10.

The host computer 3 is a computer which provides services such as automatic teller services of banks and Internet web page browsing services. The storage apparatus 10 is, for example, a disk array device which provides a data storage region to application programs and the like to be executed in the host computer 3.

The host computer 3 and the storage apparatus 10 are communicatively coupled to each other through a communication network (hereinafter referred to as a storage area network 5). The storage area network 5 is, for example, LAN (Local Area Network), WAN (Wide Area Network), SAN (Storage Area Network), the Internet, a public telecommunication network, and a private line. Communication between the host computer 3 and the storage apparatus 10 are performed in compliance with a protocol such as TCP/IP, iSCSI (internet Small Computer System Interface), Fibre Channel Protocol, FICON (Fibre Connection)(Registered Trademark), ESCON (Enterprise System Connection)(Registered Trademark), ACONARC (Advanced Connection Architecture) (Registered Trademark), or FIBARC (Fibre Connection Architecture)(Registered Trademark).

The host computer 3 transmits to the storage apparatus 10 a data frame (hereinafter abbreviated as a frame) containing a data input/output request (a data write request, a data read request, or the like) when making an access to the storage region provided by the storage apparatus 10. The frame transmitted from the host computer 3 to the storage apparatus 10 is, for example, a fibre channel frame (FC frame (FC: Fibre Channel)).

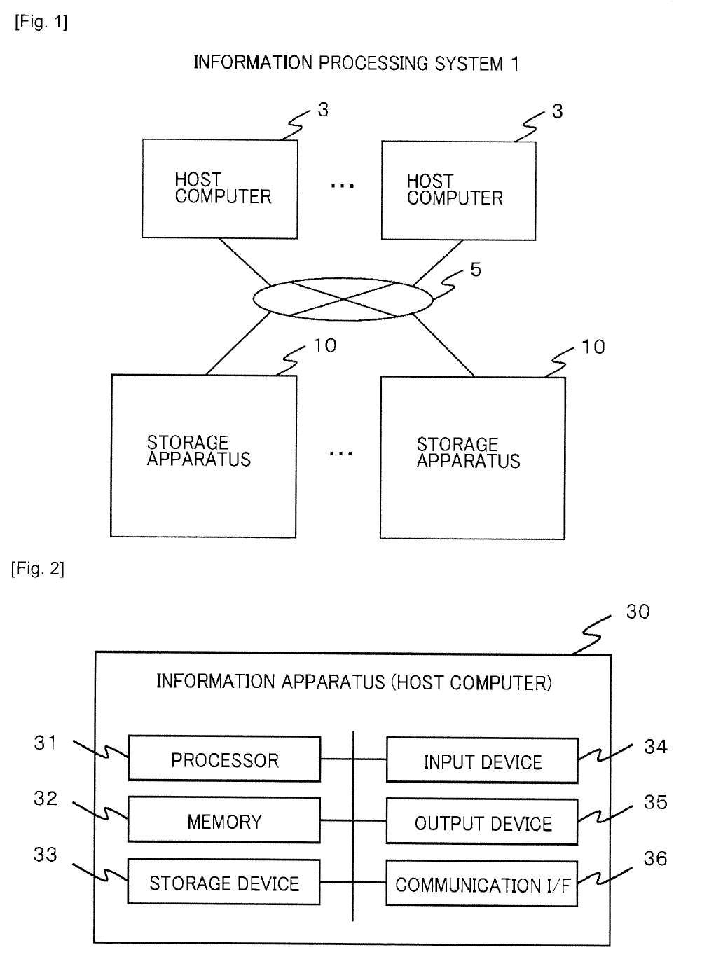

FIG. 2 shows a hardware configuration of an information apparatus (computer) shown as an example of the host computer 3. As shown in FIG. 2, this information apparatus 30 includes CPU 31, memory 32 (RAM (Random Access Memory), ROM (Read Only Memory), NVRAM (Non Volatile RAM) or the like), storage device 33 (for example, HDD (Hard Disk Drive), a semiconductor storage device (SSD (Solid State Drive))), input device 34 such as a keyboard or a mouse, output device 35 such as a liquid crystal monitor or a printer, and a communication interface (referred to as a communication I/F 36) such as a NIC (Network Interface Card) or an HBA (Host Bus Adapter). The host computer 3 is a personal computer, a mainframe, an office computer, or the like.

The memory 32 and the storage device 33 of the host computer 3 store programs and the like for implementing an operating system, a file system, and an application. The functions of the host computer 3 are obtained by the CPU 31 reading and executing these programs.

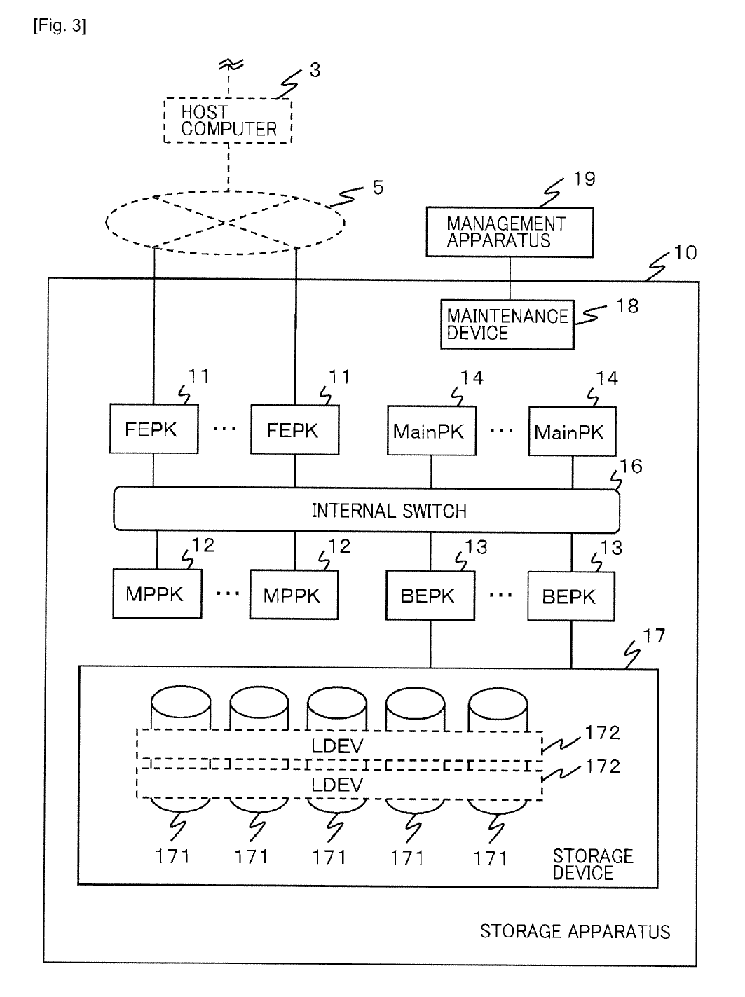

FIG. 3 shows a hardware configuration of the storage apparatus 10. As shown in FIG. 3, the storage apparatus 10 includes a plurality of front-end packages (hereinafter referred to as FEPK 11), a plurality of processor packages (hereinafter referred to as MPPK 12), at least one back-end package (hereinafter referred to as BEPK 13), a plurality of main packages (hereinafter referred to as MainPK 14), an internal switch 16, a storage device 17, and a maintenance device 18 (SVP: SerVice Processor).

As shown in FIG. 3, the FEPK 11, MPPK 12, BEPK 13, and MainPK 14 are communicatively coupled to one another through the internal switch 16. Note that each of these packages (the FEPK 11, MPPK 12, BEPK 13, and MainPK 14) is configured as, for example, a circuit board (a unit) capable of being inserted into and removed from the storage apparatus 10.

The FEPK 11 receives a frame transmitted from the host computer 3 and transmits to the host computer 3 a frame containing a response to a process of a data input/output request which is contained in the received frame (for example, data read from the storage device 17, a read completion report, or a write completion report).

In response to the data input/output request contained in the frame that the FEPK 11 has received from the host computer 3, the MPPK 12 performs a high-speed data transfer among the FEPK 11, BEPK 13, and MainPK 14. A specific example of the above-described data transfer includes handover of data read from the storage device 17 (hereinafter referred to as read data), handover of data to be written into the storage device 17 (hereinafter referred to as write data), staging (data read from the storage device 17 to CM 145) and destaging (data write from the CM 145 to the storage device 17) of the CM 145 (to be described later) provided in the MainPK 14, and the like.

The MainPK 14 includes a shared memory (hereinafter referred to as SM 144 (SM: Shared Memory)) which is a memory shared among the FEPK 11, MPPK 12, and BEPK 13 and storing data (hereinafter referred to as control information) to be used for controlling processing for a data input/output request. The MainPK 14 includes a cache memory (hereinafter referred to as CM 145 (CM: Cache Memory)) which is a memory temporarily storing data to be the target of the data input/output request.

The BEPK 13 communicates with the storage device 17 at the time of reading data from the storage device 17 or writing data into the storage device 17.

The internal switch 16 is configured using a switching device such as a high-speed cross bar switch. Communications through the internal switch 16 are performed in conformity with a protocol such as a fibre channel, iSCSI, TCP/IP, or the like. Note that, in place of the internal switch 16, a hardware bus may be used.

The storage device 17 is configured of a plurality of storage drives 171 which are physical recording media. The storage drive 171 is, for example, a hard disk drive (a hard disk drive in conformity with standards such as SAS (Serial Attached SCSI), SATA (Serial ATA), FC (Fibre Channel), PATA (Parallel ATA), SCSI, or the like), a semiconductor storage device (SSD), or the like. The storage device 17 may be housed in a casing same as that of the storage apparatus 10 or may be housed in a casing different from that of the storage apparatus 10.

The storage device 17 provides a storage region to the host computer 3 in units of logical devices (LDEVs 172 (LDEV: Logical Device)) configured using RAID (Redundant Arrays of Inexpensive (or Independent) Disks) group (parity group) based on the storage region of the storage drive 171.

The storage apparatus 10 provides to the host computer 3 a logical storage region (hereinafter referred to as LU (Logical Unit, Logical Volume)) configured using a LDEV 172. The storage apparatus 10 manages correspondences (relationship) between the LUs and the LDEVs 172, and, based on the correspondences, identifies a LDEV 172 corresponding to a certain LU or identifies an LU corresponding to a certain LDEV 172. In addition, each LU is assigned a unique identifier (hereinafter referred to as LUN (Logical Unit Number)). The host computer 3 sets this LUN to a frame to be transmitted to the storage apparatus 10 so as to designate an LU to be the access destination.

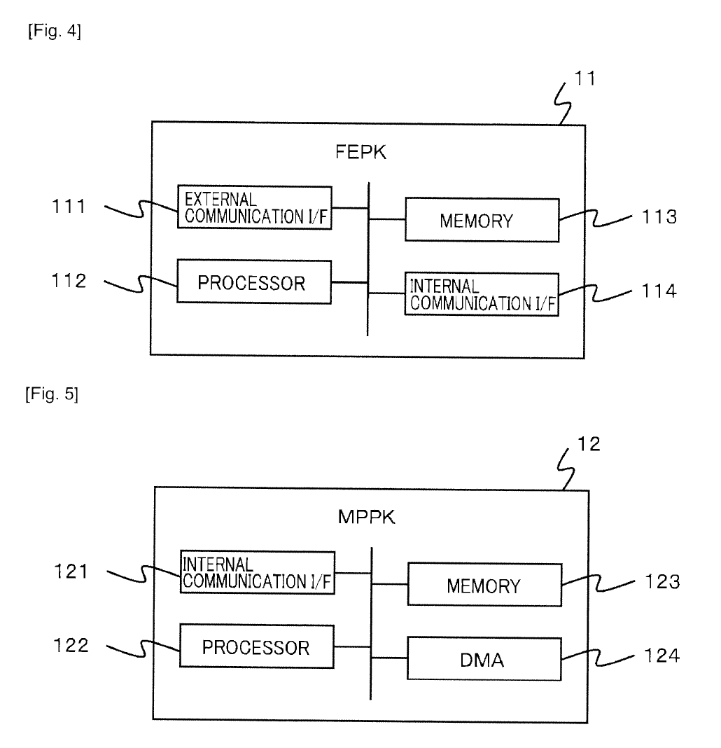

FIG. 4 shows a hardware configuration of a FEPK 11. As shown in FIG. 4, the FEPK 11 includes an external communication interface (hereinafter referred to as an external communication I/F 111), processor 112 (including a frame processing chip and a frame transfer chip), memory 113, and an internal communication interface (hereinafter referred to as an internal communication I/F 114).

Among these, the external communication I/F 111 has at least one port (a communication port) for communicating with the host computer 3. The external communication I/F 111 is configured using a network interface such as NIC (Network Interface Card) or HBA (Host Bus Adapter).

The processor 112 is configured using a CPU (Central Processing Unit) or MPU (Micro Processing Unit), for example.

The memory 113 is configured using a RAM, ROM, or NVRAM, for example. The memory 113 stores a micro program. The processor 112 reads and executes the micro program from the memory 113 to implement various functions provided by the FEPK 11.

The internal communication I/F 114 performs communications with the MPPK 12, BEPK 13, and MainPK 14 through the internal switch 16.

The external communication I/F 111 communicates with the host computer 3 through the storage area network 5 in compliance with a predetermined protocol (communication protocol).

FIG. 5 shows a hardware configuration of MPPK 12. As shown in FIG. 5, the MPPK 12 includes an internal communication interface (hereinafter referred to as an internal communication I/F 121), processor 122, and memory 123.

The internal communication I/F 121 performs communications with the FEPK 11, BEPK 13, and MainPK 14 through the internal switch 16.

The processor 122 is configured using, for example, a CPU or MPU.

The memory 123 is configured using, for example, a RAM, ROM, or NVRAM. The memory 123 stores a micro program. The processor 122 reads and executes the above-mentioned micro program from the memory 123 so as to implement various functions provided by the MPPK 12.

A DMA 124 (DMA: Direct Memory Access) performs data transfer among the FEPK 11, BEPK 13, and MainPK 14 according to a transfer parameter set (designated) in the memory 123 by the processor 122.

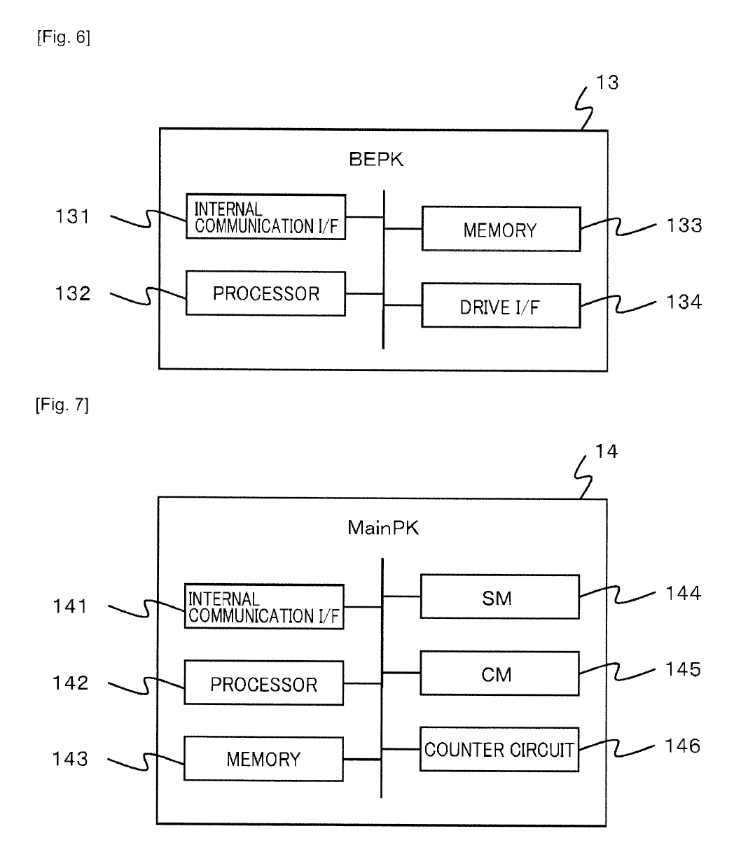

FIG. 6 shows a hardware configuration of BEPK 13. As shown in FIG. 6, the BEPK 13 includes an internal communication interface (hereinafter referred to as an internal communication I/F 131), processor 132, memory 133, and a drive interface (hereinafter referred to as a drive I/F 134).

The processor 132 is configured using, for example, a CPU or MPU. The memory 133 is configured using, for example, a RAM, ROM, or NVRAM. The memory 133 stores a micro program. The processor 132 reads and executes the micro program from the memory 133 so as to implement various functions provided by the BEPK 13.

The internal communication I/F 131 communicates with the FEPK 11, MPPK 12, and MainPK 14 through the internal switch 16. The drive 1/F 134 communicates with the storage device 17.

FIG. 7 shows a hardware configuration of MainPK 14. As shown in FIG. 7, the MainPK 14 includes an internal communication interface (hereinafter referred to as an internal communication I/F 141), processor 142, memory 143, shared memory (SM 144), a cache memory (CM 145), and counter circuit 146.

The internal communication I/F 141 communicates with the FEPK 11, MPPK 12, and BEPK 13 through the internal switch 16.

The processor 142 is configured using, for example, a CPU or MPU. The memory 143 is configured using, for example, a RAM, ROM, or NVRAM. The memory 143 stores a micro program. The processor 142 reads and executes the micro program from the memory 143 so as to implement various functions provided by the MainPK 14.

The SM 144 is configured using, for example, a RAM, ROM, or NVRAM. The SM 144 stores the above-described control information, data to be used for the maintenance and management of the storage apparatus 10, and the like.

The CM 145 is configured using, for example, a RAM or NVRAM. The CM 145 temporarily stores the above-described cache data (data to be written into the storage device 17 (hereinafter referred to as write data) and data read from the storage device 17 (hereinafter written as read data)).

The counter circuit 146 counts the number of updates of the control information stored in a given storage region of the SM 144 and holds the counted value as an update counter value. The counter circuit 146 is implemented as a hardware logic such as ASIC (Application Specific Integrated Circuit) or FPGA (Field-Programmable Gate Array).

The maintenance device 18 shown in FIG. 3 is configured using a personal computer, an office computer, or the like. The maintenance device 18 communicates with the FEPK 11, MPPK 12, BEPK 13, and MainPK 14 through the internal switch 16 or a communication unit provided inside the storage apparatus 10. In addition, the maintenance device 18 acquires operation information and the like from the components of the storage apparatus 10 and provides the acquired information to the management apparatus 19. Moreover, the maintenance device 18 performs processing relating to the setting, control, maintenance (including introduction or update of software), or the like of the components on the basis of the control information and the operation information which are transmitted from the management apparatus 19.

The management apparatus 19 is a computer which is communicatively coupled to the maintenance device 18 through a LAN or the like. The management apparatus 19 includes a user interface which is configured using a GUI (Graphical User Interface), CLI (Command Line Interface), or the like for controlling or monitoring the storage apparatus 10.

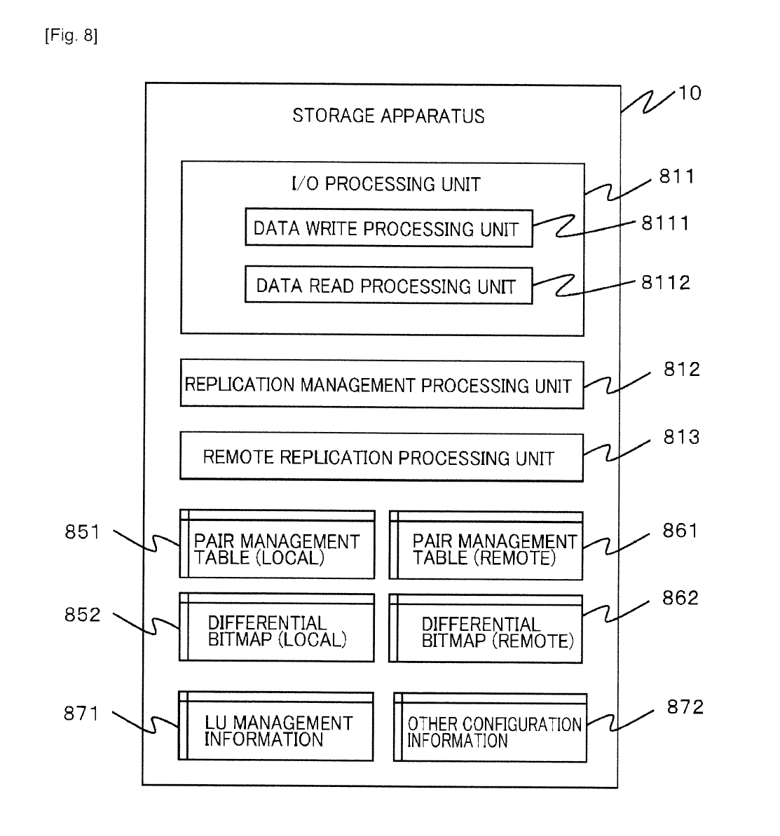

FIG. 8 shows the main functions of the storage apparatus 10 which relate to the execution of processing of a data input/output request transmitted from the host computer 3. As shown in FIG. 8, the storage apparatus 10 includes I/O processing unit 811, replication management processing unit 812, and remote replication processing unit 813. Note that, functions of the I/O processing unit 811 are implemented by hardware included in the FEPK 11, MPPK 12, BEPK 13, and MainPK 14 of the storage apparatus 10 or by the processors 112, 122, 132, and 142 reading and executing the micro programs stored in the memories 113, 123, 133, and 143.

As shown in FIG. 8, the I/O processing unit 811 includes a data write processing unit 8111 which performs processing related to data writing into the storage device 17 and a data read processing unit 8112 which performs processing related to data reading from the storage device 17.

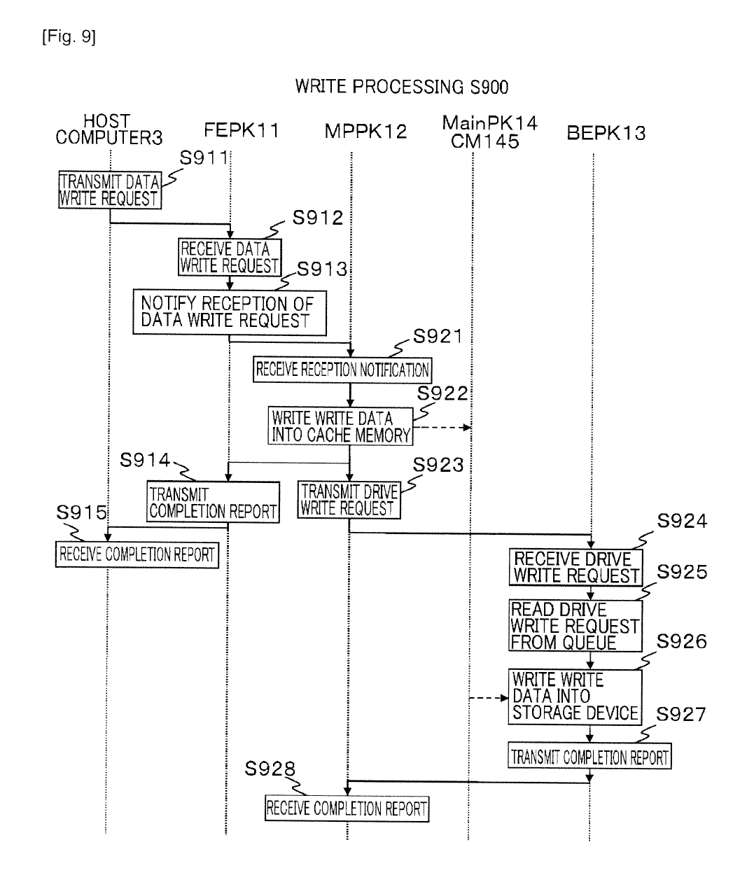

FIG. 9 is a view for illustrating functions of the data write processing unit 8111 of the I/O processing unit 811 and is a flowchart for illustrating processing (hereinafter referred to as write processing 5900) which is performed when the storage apparatus 10 receives a frame containing a data write request from the host computer 3. In the following, the write processing 5900 is described with reference to FIG. 9. Note that, in the following description, the letter “S” before a reference number means a processing step.

As shown in FIG. 9, first the FEPK 11 of the storage apparatus 10 receives a frame containing a data write request transmitted from the host computer 3 (S911, S912) and notifies the MPPK 12 of the reception (S913).

Upon receiving the notification from the FEPK 11 (S921), the MPPK 12 creates a drive write request based on the data write request of the frame and stores the write data in the cache memory (CM 145) of the MainPK 14, and sends the FEPK 11 a reception notification in response to the above notification (S922). Also, the MPPK 12 transmits the created drive write request to the BEPK 13 (S923).

Upon receiving the response from the MPPK 12, the FEPK 11 transmits a completion report to the host computer 3 (S914). The host computer 3 receives the completion report from the FEPK 11 (S915).

Upon receiving the drive write request from the MPPK 12, the BEPK 13 registers the received drive write request in a waiting queue for the write processing (S924).

The BEPK 13 reads the drive write request from the waiting queue for write processing as needed (S925). Also, the BEPK 13 reads, from the cache memory (CM 145) of the MainPK 14, write data designated by the read drive write request and writes the read write data into the storage device (storage drive 171) (S926). Further, the BEPK 13 notifies the MPPK 12 of a report on the completion (completion report) of writing the write data in response to the drive write request (S927).

The MPPK 12 receives the completion report transmitted from the BEPK 13 (S928).

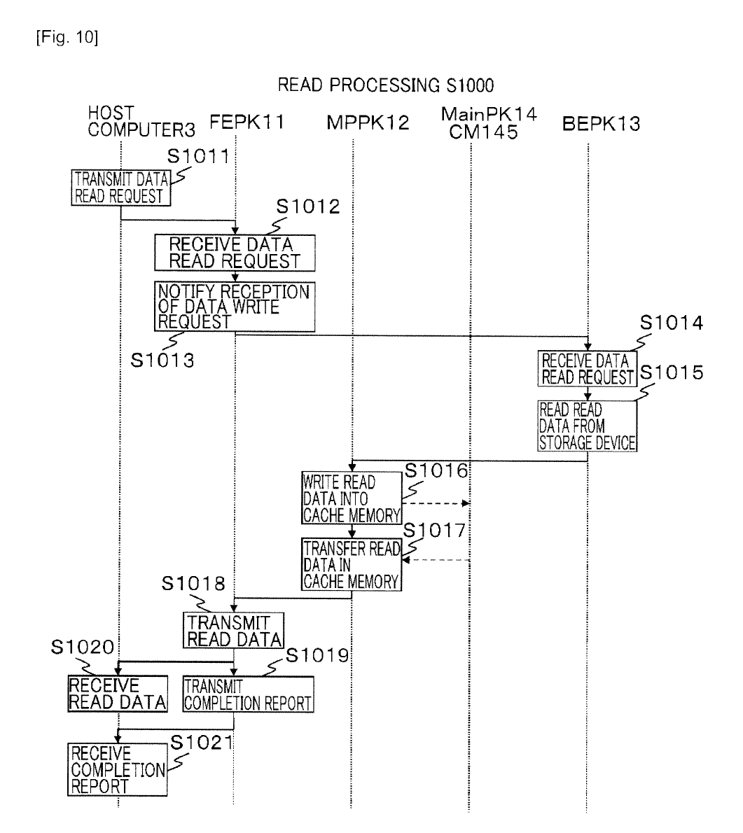

FIG. 10 is a view for illustrating functions of the data read processing unit 8112 of the I/O processing unit 811 and is a flowchart for illustrating processing (hereinafter referred to as read processing S1000) which is performed when the storage apparatus 10 receives a frame containing a data read request from the host computer 3. In the following, the read processing S1000 is described with reference to FIG. 10.

As shown in FIG. 10, first the FEPK 11 of the storage apparatus 10 receives a frame which is transmitted from the host computer 3 (S1011, S1012).

Upon receiving the frame, the FEPK 11 notifies the BEPK 13 of the reception (S1013).

Upon receiving the notification from the FEPK 11 (S1014), the BEPK 13 reads, from the storage device 17, data designated by the data read request contained in the frame (for example, designated by LBA (Logical Block Address)) (S1015). Note that, if the read data is present in the cache memory (CM 145) of the MainPK 14 (if staging is performed), the read processing (S1015) from the storage device 17 is omitted.

The MPPK 12 writes the data read by the BEPK 13 into the cache memory (CM 145) (S1016). Then, the MPPK 12 transfers the data written into the cache memory (CM 145), to the FEPK 11 as needed (S1017).

The FEPK 11 receives the read data which is transmitted from the MPPK 12 and transmits the received read data to the host computer 3 (S1018). When the transmission of the read data to the host computer 3 is completed, the FEPK 11 transmits a completion report to the host computer 3 (S1019). The host computer 3 receives the read data and the completion report (S1020, S1021).

### Replication Management Function

The replication management processing unit 812 shown in FIG. 8 provides a function of storing a replica of data stored in a certain LU (hereinafter referred to as a replication source LU) in also another LU (hereinafter referred to as a replication destination LU) (such a function is hereinafter referred to as a replication management function (local copy)). The replication management function is introduced in the storage apparatus 10 for the purpose of ensuring data security and data integrity.

As shown in FIG. 8, the storage apparatus 10 manages a pair management table (local) 851 and a differential bitmap 852 (local), which are tables to be accessed by the replication management processing unit 812. These tables are stored in the shared memory (SM 144) of the MainPK 14 as the above-mentioned control information.

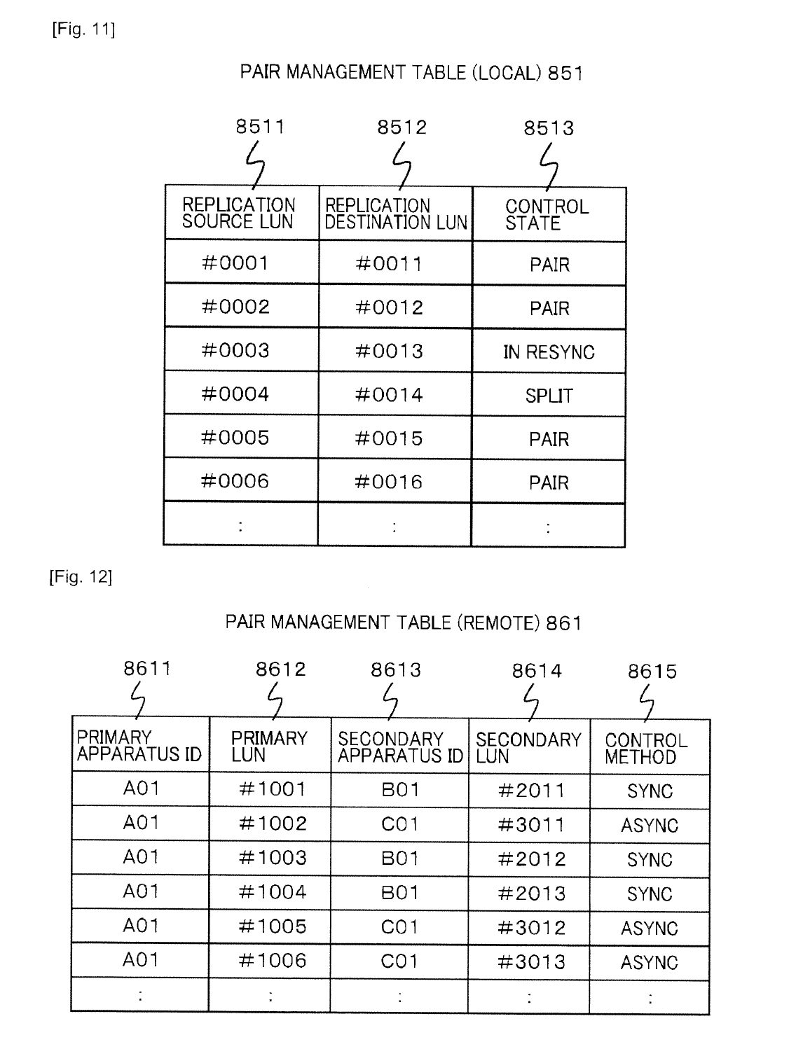

FIG. 11 shows an example of the pair management table (local) 851. As shown in FIG. 11, at least one record including items of replication source LUN 8511, replication destination LUN 8512, and replication management function control state 8513, is registered in the pair management table (local) 851. Note that the contents of the pair management table (local) 851 are set in such a manner that an operator of the storage apparatus 10 operates the management apparatus 19, for example.

In the replication source LUN 8511 of the pair management table (local) 851, an LUN of the replication source LU is set. Meanwhile, in the replication destination LUN 8512 of the pair management table (local) 851, an LUN of the replication destination LU which is associated with the replication source LU that is identified by the replication source LUN 8511 of the corresponding record, is set.

Information set in the control state 8513 is on the current state of control by the replication management function on the combination (hereinafter referred to as a local pair) of the replication source LU and replication destination LU of the record. The control state includes a pair state, a split state, and a resync state.

In the pair state, replication of the replication source LU to the replication destination LU is performed in real-time. Specifically, when the content of the replication source LU is changed by the data input/output request from the host computer 3, the changed content is also immediately reflected in the replication destination LU. If the local pair is in a pair state, “pair” is set in the control state 8513 of the pair management table (local) 851.

In the split state, even when the content of the replication source LU is changed, the changed content is not immediately reflected in the replication destination LU, but is reflected in the replication destination LU when the local pair transitions again from the split state to the pair state (hereinafter referred to as resync). If the local pair is in a split state, “split” is set in the control state 8513 of the pair management table (local) 851. If the local pair is currently transitioning from a split state to the pair state, “in resync” is set in the control state 8513 of the pair management table (local) 851.

The replication management processing unit 812 manages, in the differential bitmap (local) 852 which is a table provided for each local pair, whether or not the content of each data block of the replication source LU is changed while the local pair is in the split state. The differential bitmap (local) 852 includes a bit corresponding to each data block included in the replication source LU. When the content of a certain data block of the replication source LU is changed by the data input/output request from the host computer 3, the bit corresponding to the data block is turned ON (set). Note that, the bit that has been turned ON is turned OFF (reset) when the resync of the corresponding pair is completed.

The control state of each pair is switched by an instruction from the management apparatus 19, for example. In other words, when an instruction to transition the local pair from the pair state to the split state (a split instruction) is made, the replication management processing unit 812 transitions the control state of the local pair from the pair state to the split state. When an instruction to transition the local pair from the split state to the pair state (a resync instruction) is made, the replication management processing unit 812 transitions the control state of the local pair from the split state to the pair state.

### Remote Replication Function

The remote replication processing part 813 shown in FIG. 8 implements a function to store a replica of data stored in a certain LU (hereinafter referred to as a primary LU) of the storage apparatus 10 (hereinafter referred to as a primary apparatus) also in an LU (hereinafter referred to as a secondary LU) of a storage apparatus 10 different from the storage apparatus 10 (hereinafter referred to as a secondary apparatus) (such a function is hereinafter referred to as a remote replication function (remote copy)). The remote replication function is introduced in the storage apparatus 10 integrity.

As shown in FIG. 8, the storage apparatus 10 manages a pair management table (remote) 861 and a differential bitmap 862 (remote), which are tables to be accessed by the remote replication processing unit 813. These tables are stored in the shared memory (SM 144) of the MainPK 14 as the control information.

FIG. 12 shows an example of a pair management table (remote) 861. As shown in FIG. 12, at least one record including items of primary apparatus ID 8611, primary LUN 8612, secondary apparatus ID 8613, secondary LUN 8614, and control method 8615 is registered in the pair management table (remote) 861. Note that the content of the pair management table (remote) 861 is set by an operator of the storage apparatus 10 operating the management apparatus 19, for example.

In the primary apparatus ID 8611 of the pair management table (remote) 861, an identifier of primary apparatus 10 (which is normally the storage apparatus 10) is set. In the primary LUN 8612, an LUN of the primary LU is set.

An identifier of a secondary apparatus is set in the secondary apparatus ID 8613. An LUN of the secondary LU of the secondary apparatus is set in the secondary LUN 8614. This LUN is associated with the primary LU which is identified by the primary apparatus ID 8611 and the primary LUN 8611 of the corresponding record.

Information set in the control method 8615 is on the method currently employed by the remote replication function to control the combination (hereinafter referred to as a remote pair) of the primary LU and secondary LU of the record. The above control method includes a synchronous method and an asynchronous method. Note that, the control method of each remote pair is switched by an instruction from the management apparatus 19, for example.

In the synchronous method, upon receiving the data write request to the primary LU from the host computer 3, the primary apparatus writes the data designated by the data write request into the primary LU. In addition, the primary apparatus transmits the data same as the data written to the secondary apparatus. Upon receiving the data from the primary apparatus, the secondary apparatus writes the data into the secondary LU and notifies the primary apparatus that the data has been written. Upon receiving the notification, the primary apparatus transmits a completion notification to the host computer 3.

As described above, in the synchronous method, the completion notification is transmitted to the host computer 3 after it is confirmed that the data has been written into both the primary LU and the secondary LU. For this reason, in the synchronous method, the conformity between the content of the primary LU and the content of the secondary LU is always secured at the time the host computer 3 receives the completion notification.

On the other hand, in the case of the asynchronous method, upon receiving the data write request to the primary LU from the host computer 3, the primary apparatus writes the data designated by the data write request into the primary LU and transmits a completion notification to the host computer 3. In addition, the primary apparatus transmits the data same as the data written to the secondary apparatus. Upon receiving the data from the primary apparatus, the secondary apparatus writes the data into the secondary LU and notifies the primary apparatus that the data has been written. As described above, in the case of the asynchronous method, once writing the data into the primary LU, the primary apparatus transmits a completion notification to the host computer 3 regardless of whether the data has been written into the secondary LU or not.

In the differential bitmap (remote) 862 shown in FIG. 8 which is provided for each remote pair, the remote replication processing part 813 manages whether or not the content of each data block of the primary LU of a remote pair in which the asynchronous method is set has been changed. The differential bitmap (remote) 862 includes a bit corresponding to each data block included in the primary LU. When the content of a certain data block of the primary LU is changed by the data input/output request from the host computer 3, the bit corresponding to the data block is turned ON (set). Note that, the bit that has been turned ON is turned OFF (reset) when the content of the secondary LU is updated and thereby the contents of the remote pair match each other (synchronized).

Configuration Information of Storage Apparatus

As shown in FIG. 8, the storage apparatus 10 manages (stores) various pieces of information which relate to the setting and configuration of the storage apparatus 10 (hereinafter referred to as configuration information) and which are needed for processing data input/output requests transmitted from the host computer 3, in the shared memory (SM 144) of the MainPK 14 as the control information as LU management information 871.

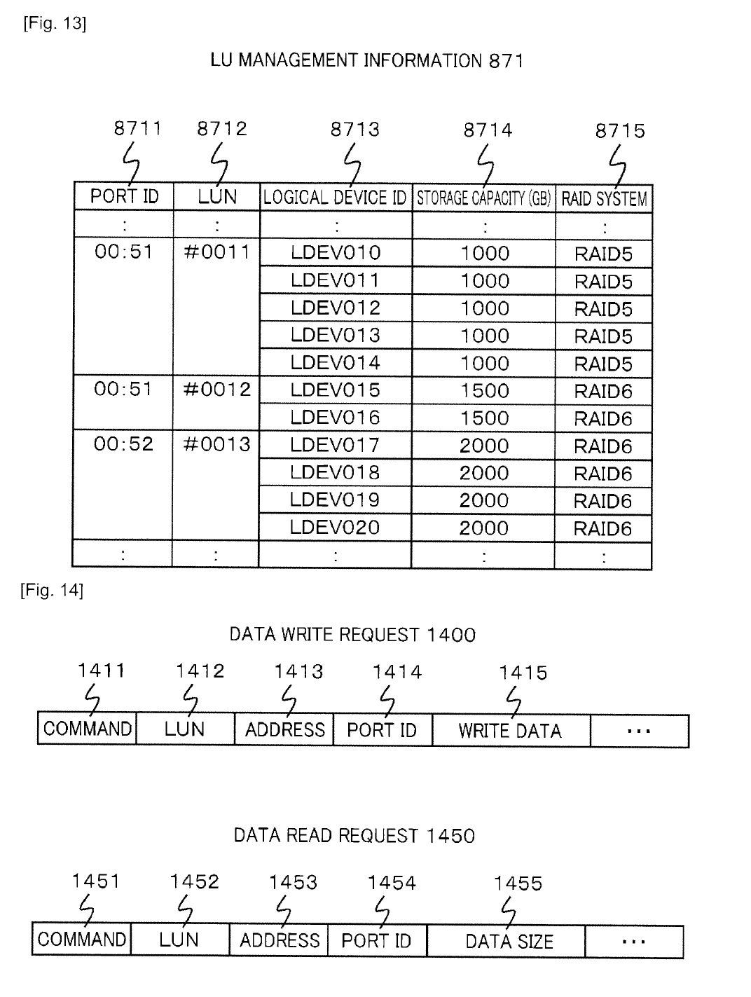

FIG. 13 shows an example of the LU management information 871. As shown in FIG. 13, the LU management information 817 manages therein correspondences among: an identifier of a communication port included in the FEPK 11 (port ID 8711); an identifier of an LU (LUN 8712); an identifier of a logical device (logical device ID 8713); storage capacity 8714 of the logical device; and RAID system 8715 supported by the logical device. The identifier of a communication port included in the FEPK 11 is, for example, WWN (World Wide Name) which is a network address of SAN (Storage Area Network).

FIG. 14 shows an example of a data write request 1400 and data read request 1450 which are transmitted from the host computer 3 to the storage device 10 in the data input/output to/from the storage device 17.

As shown in FIG. 14, the data write request 1400 includes command 1411 (in this case, a command being an instruction to write data is set), LUN 1412 of a data write destination, address 1413 (an address for identifying a write-destination storage region of the LU (for example, LBA (Logical Block Address) is set), port ID 1414 (an identifier of the communication port), write data 1415, and the like. Upon receiving a data write request 1400 shown in FIG. 14, the storage apparatus 10 identifies the logical device (LDEV) which is a data write destination with reference to the LU management information 871.

Moreover, as shown in FIG. 14, the data read request 1450 includes command 1451 (in this case, a command being an instruction to read data is set), LUN 1452 of a data read destination, address 1453 (an address for identifying a data-read-destination storage region of the LU (for example, LBA) is set), port ID 1454 (an identifier of the communication port), data size 1455 of read-target data, and the like. Upon receiving a data read request 1450 shown in FIG. 14, the storage apparatus 10 identifies the logical device (LDEV) which is a data read destination with reference to the LU management information 871.

Note that, in addition to the LU management information 871, the storage apparatus 10 manages various pieces of other configuration information (other configuration information 872) as the above-described control information in the shared memory (SM memory 144) of the MainPK 14, according to the functions (for example, Thin Provisioning, storage pool, and the like) implemented in the storage apparatus 10.

Control Information Redundancy Management Function

Basic services of the storage apparatus 10 may be affected if the content of the control information (for example, the pair management table (local) 851, differential bitmap (local) 852, pair management table (remote) 861, differential bitmap (remote) 862, LU management information 871, other configuration information 872) stored in the shared memory (SM 144) of the MainPK 14 is damaged due to a failure in the storage apparatus 10. For this reason, in order to secure the reliability and integrity of the control information, the storage apparatus 10 includes a function to redundantly manage (multiplex management), in shared memories (SM 144) of multiple MainPKs 14, the control information stored in the shared memory (SM 144) of the MainPK 14.

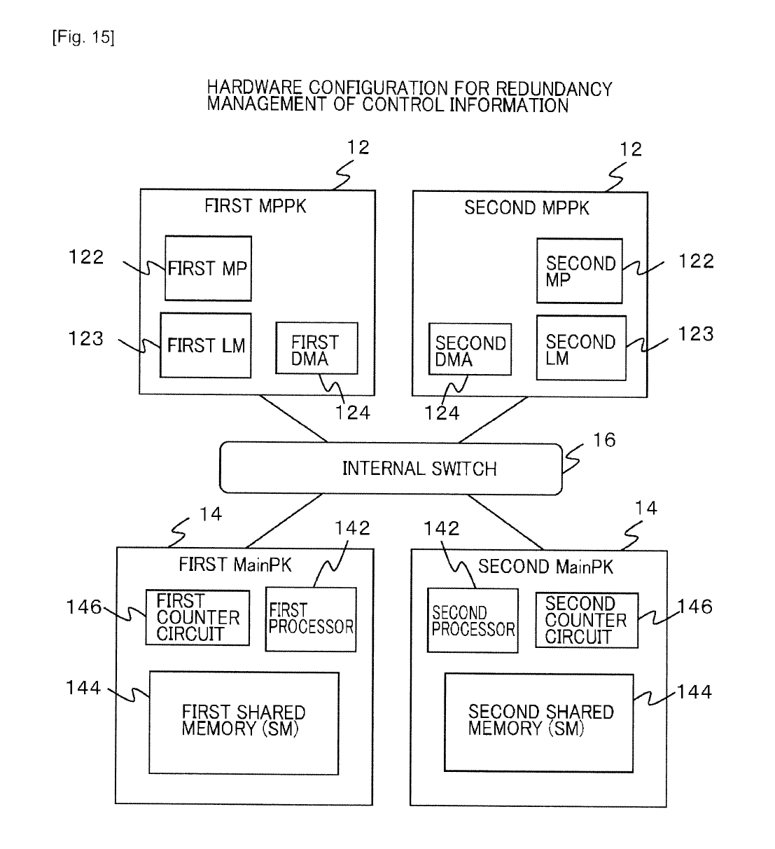

FIG. 15 is a view showing a part of the components of the storage apparatus 10 which contributes to implementation of the redundancy management function, in order to illustrate the redundancy management function. In FIG. 15, both first MPPK 12 and second MPPK 12 are components of the same storage apparatus 10. Moreover, in FIG. 15, both first MainPK 14 and second MainPK 14 are components of the same storage apparatus 10.

As shown in FIG. 15, the first MPPK 12 includes first processor 122 (hereinafter referred to as first MP 122), first memory 123 (hereinafter referred to as first LM 123 (LM: Local Memory)), and first DMA 124. Meanwhile, the first MainPK 14 includes first processor 142, first counter circuit 146, and first shared memory (SM 144).

On the other hand, the second MPPK 12 includes second processor 122 (hereinafter referred to as second MP 122), second memory 123 (hereinafter referred to as second LM 123), and a second DMA 124. Meanwhile, the second MainPK 14 includes second processor 142, second counter circuit 146, and second shared memory (SM 144).

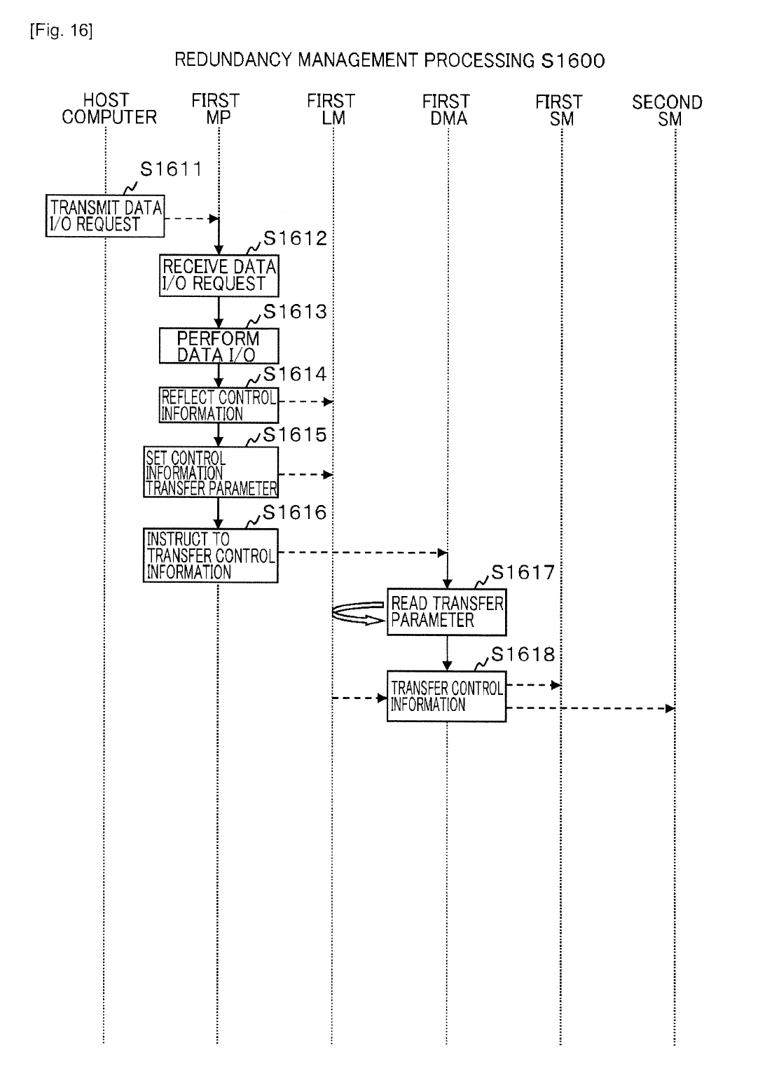

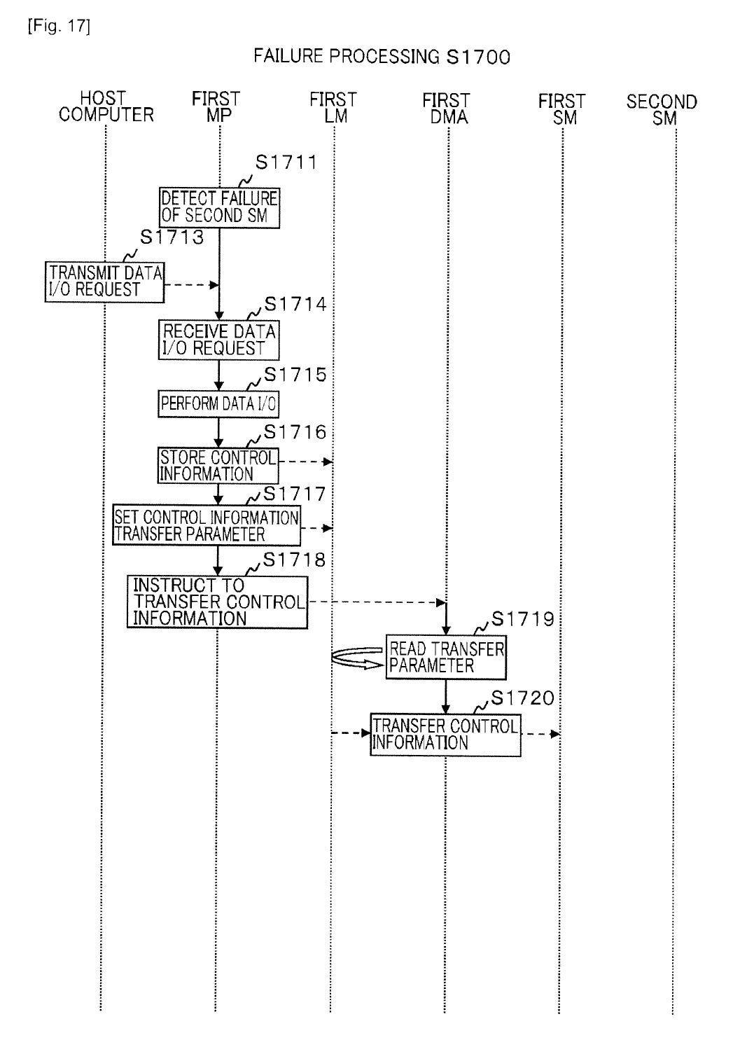

FIG. 16 is a flowchart for illustrating processing for the redundancy management (hereinafter referred to as redundancy management processing 1600) by mainly using the hardware configuration shown in FIG. 15. In the following, the redundancy management 1600 is described with reference to FIG. 16. Note that, in a normal state (a general state), the redundancy management processing 1600 is performed by using any one of the first MP 122 and the second MP 122 as main (master) and the other as follower (slave). In the following description, it is assumed that the first MP 122 serves as the main (master).

First of all, when a data input/output request is transmitted from the host computer 3 to the storage apparatus 10 (S1611), the first MP 122 of the first MPPK 12 receives the request (S1612).

Upon receiving the data input/output request, the first MP 122 performs processing (data input/output) (processing described using FIG. 9 and FIG. 10) on the storage device 17 in response to the received data input/output request (S1613).

The first MP 122 creates control information (which may include update information of the control information) as needed when performing the above processing and reflects the created control information in the first LM 123 (or updates the control information stored in the first LM 123) (S1614).

Thereafter, the first MP 122 sets a transfer parameter in the first LM 123 for transferring the control information from the first LM 123 to the first SM 144 and the second SM 144 (S1615), and sends the first DMA 124 an instruction to transfer the control information (S1616).

Upon receiving the transfer instruction, according to the transfer parameter stored in the first LM 123 (S1617), the first DMA 124 transfers the control information stored in the first LM 123 to the first SM 144 and the second SM 144 (S1618).

As described above, the control information is redundantly managed (stored) in both the first SM 144 and the second SM 144 by the redundancy management processing 1600.

Failure Processing

When the second SM 144 becomes unavailable due to a failure (for example, a communication failure or a hardware failure) caused in the second SM 144 at the time of performing the redundancy management processing 1600, the redundancy management is interrupted. Thus, during the interruption, the created (or changed) control information is reflected only in the first SM M4.

FIG. 17 is a flowchart for schematically illustrating the processing (hereinafter referred to as failure processing S1700) which is performed in the storage apparatus 10 while the second SM 144 is unavailable. Hereinafter, the failure processing 51700 is described with reference to FIG. 17.

After detecting that the second SM 144 becomes unavailable (S1711), and receives a data input/output request from the host computer 3 (S1713, S1714) the first MP 122 performs data input/output on the storage device 17 in response to the data input/output request and stores in the first LM 123 the control information updated as a result of the data input/output (S1715, S1716).

Thereafter, the first MP 122 stores (sets) a transfer parameter for transferring, in the first LM 123, the control information stored in the first LM 123 from the first LM 123 to the first SM 144 (S1717), and sends the first DMA 124 an instruction to transfer the control information (S1718).

Upon receiving the transfer instruction, the first DMA 124 reads the above transfer parameter stored in the first LM 123 (S1719), and, according to the content of the transfer parameter, transfers the control information stored in the first LM 123 to the first SM 144 (S1720).

As described above, the control information updated while the second SM 144 is unavailable is reflected only in the first SM 144. Note that, even in the case where the maintenance is made on the second SM 144 or the second SM 144 is increased or decreased in capacity, for example, the redundancy management function is similarly interrupted and the failure processing S1700 is executed.

Failure Recovery Processing

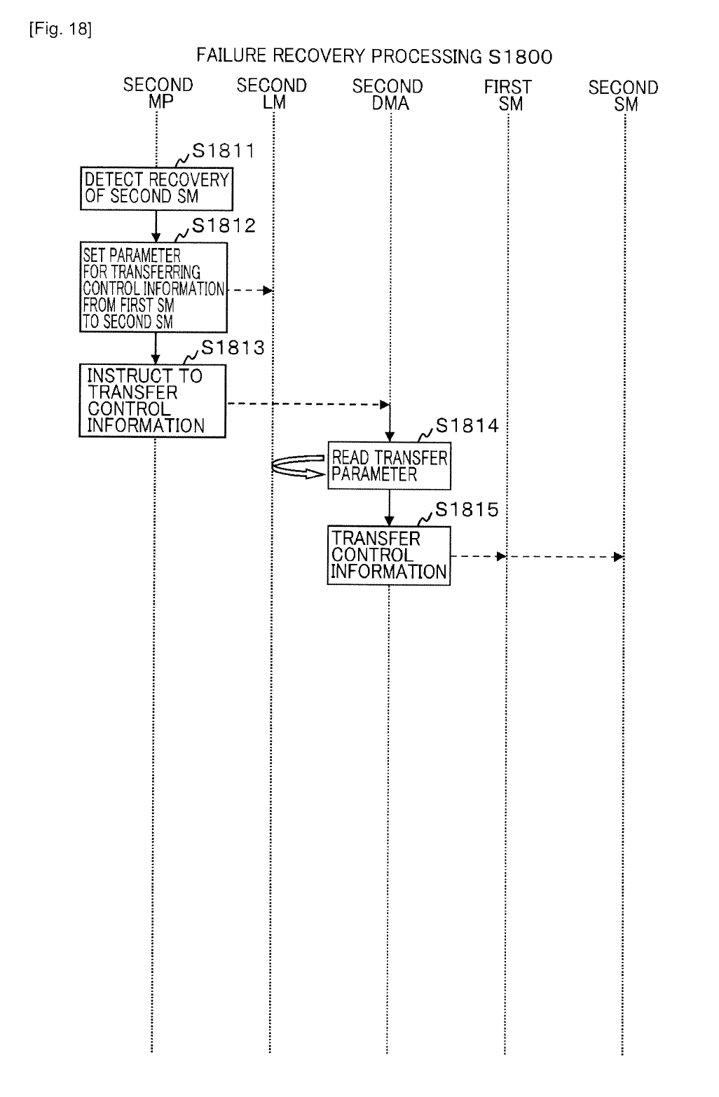

Next, once the failure of the second SM 144 is recovered (or maintenance or increasing/decreasing the capacity is completed), the redundancy management processing S1600 is restarted. FIG. 18 is a flowchart for schematically illustrating the processing (hereinafter referred to as failure recovery processing S1800) performed in the storage apparatus 10 when the second SM 144 is recovered and the redundancy management processing S1600 is restarted. In the following, the failure recovery processing S1800 is described with reference to FIG. 18.

Upon detecting that the second SM 144 has recovered (S1811), the second MP 122 sets, in the second LM 123, a transfer parameter for transferring to the second SM 144 control information stored in the first SM 144 (S1812) and sends the second DMA 124 an instruction to transfer the control information (S1813).

Upon receiving the above transfer instruction, the second DMA 124 reads the transfer parameter stored in the second LM 123 (S1814), and, according to the content of the read transfer parameter, transfers the control information stored in the first SM 144 to the second SM 144 (S1815).

Re-Execution of Control Information Transfer Processing

Upon detecting that the second SM 144 has recovered (S1811 in FIG. 18), the storage apparatus 10 immediately restarts the redundancy management processing S1600. For this reason, even while the control information is transferred from the first SM 144 to the second SM 144 (S1815), in a case the control information of the first SM 144 is updated, the content thereof is reflected in the second SM 144 (S1613 to S1618 in FIG. 16). Thus, there is a possibility that after the control information of the second SM 144 is updated (S1619 in FIG. 16), the control information is transferred from the first SM 144 to the second SM 144 (S1815) and the old control information is overwritten on the control information of the second SM 144. In this case, the content of the first SM 144 and the content of the second SM 144 become inconsistent (mismatch). As a measure against this, the storage apparatus 10 of the present embodiment includes a mechanism of re-executing the transfer processing (repeating the processing from the beginning) of the control information (S1815) (the transfer processing of all pieces of control information designated by the transfer parameter set in S1812) upon detecting that the control information is updated during the transfer of the control information (S1815).

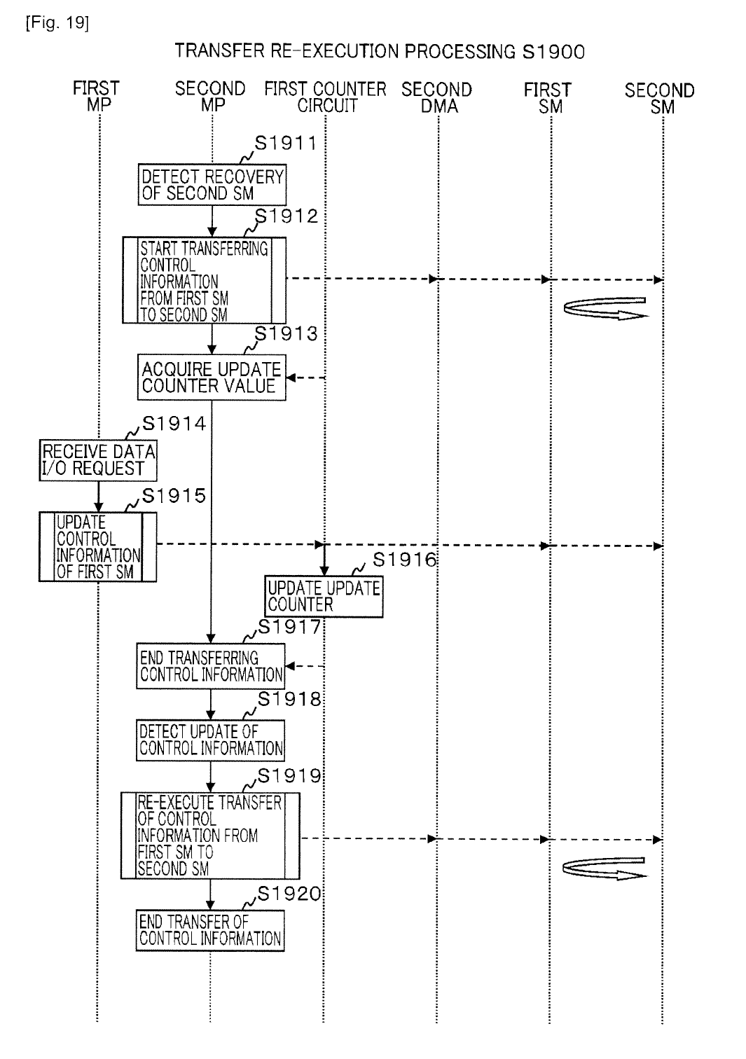

FIG. 19 is a flowchart for schematically illustrating the processing (hereinafter, referred to as transfer re-execution processing S1900) performed in the storage apparatus 10 when the processing of transferring all the pieces of control information is re-executed. In the following, the transfer re-execution processing S1900 is described with reference to FIG. 19.

Upon detecting that the second SM 144 has recovered (S1911) (S1811 in FIG. 18), the second MP 122 starts transferring control information from the first SM 144 to the second SM 144 (S1812 to S1815 in FIG. 18) (S1912). Also, prior to starting the transfer processing, the second MP 122 acquires an update counter value of the control information to be transferred by the above transfer processing from the first counter circuit 146 (S1913).

Here, during the transfer processing (S1913), when the first MP 122 receives a data input/output request from the host computer 3 (S1612 in FIG. 16) (S1914), control information of each of the first SM 144 and the second SM 144 is updated (S1613 to S1618 in FIG. 16) (S1915), and the update counter value of the first SM 144 is updated (S1916).

When the transfer processing of the control information (S1912) ends (S1917), the second MP 122 acquires an update counter value from the first counter circuit 146 and compares the acquired update counter value with the update counter value acquired in S1913. When the acquired update counter value in the transfer target region is different from the update counter value acquired in S1913 (S1918), the second MP 122 re-executes the transfer processing of the control information from the first SM 144 to the second SM 144 (S1812 to S1815 in FIG. 18) (S1919). On the other hand, when the acquired update counter value in the transfer target region is same as the update counter value acquired in S1913 (in other words, if no update is performed on the control information during the transfer), the transfer re-execution processing S1900 ends (S1920).

Transfer Range Division

In the meantime, in the above transfer re-execution processing S1900, when the control information (control information of each of the first SM 144 and second SM 144) which is a transfer target is updated during the transfer of the control information (S1815, S1912), transfer of the entire control information is re-executed. For this reason, when the control information is repeatedly updated, transfer of the control information may take a long time. Thus, the storage apparatus 10 of the present embodiment includes a mechanism of reducing a possibility of updating the control information being the transfer target by making the transfer range of the control information narrower than that in the previous transfer when the transfer of the control information is re-executed.

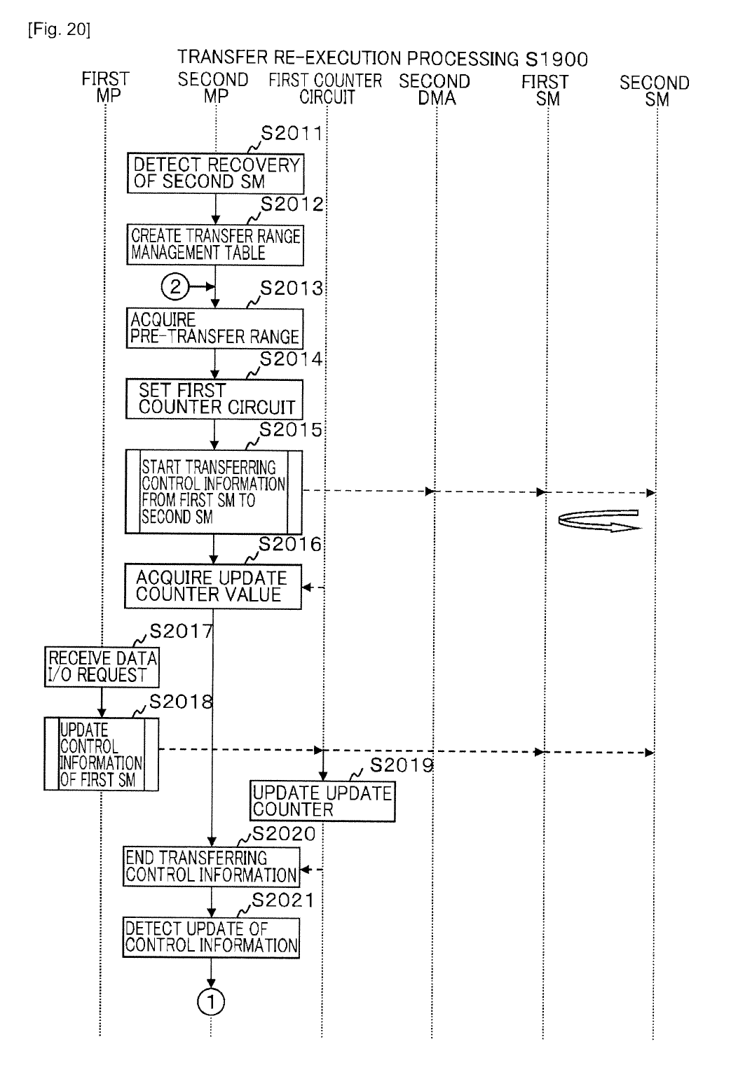

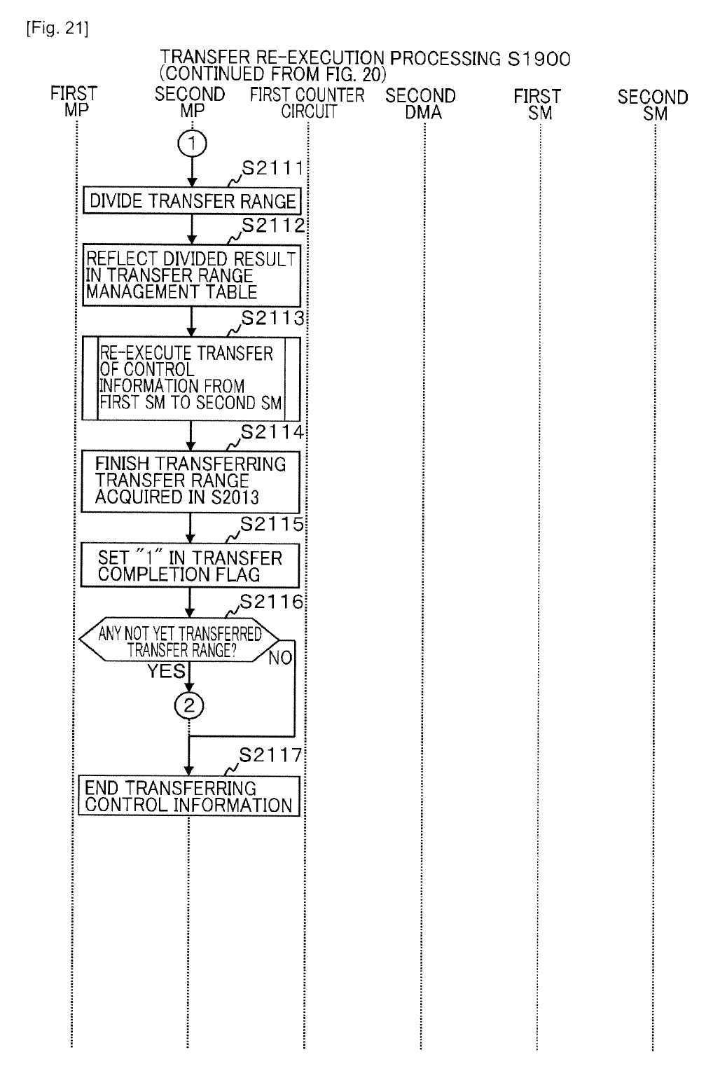

FIG. 20 and FIG. 21 are flowcharts for illustrating the above-described transfer re-execution processing S1900 including the processing for the above mechanism. In the following, description is given with reference to these drawings.

Upon detecting that the second SM 144 has recovered (S1911 in FIG. 19) (S2011), the second MP 122 creates, in the second LM 123, a transfer range management table 2200 for managing the transfer range (S2012).

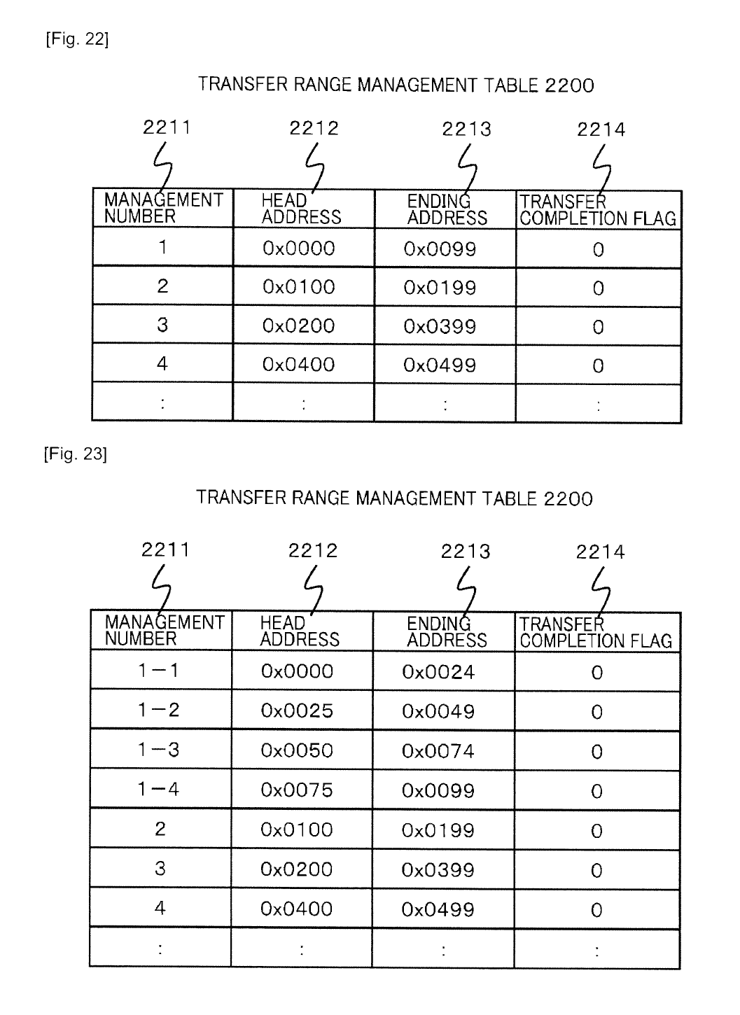

FIG. 22 shows an example of the transfer range management table 2200. As shown in FIG. 22, the transfer range management table 2200 includes at least one record including items of management number 2211, head address 2212, ending address 2213, and transfer completion flag 2214.

Among these items, in the management number 2211, an identifier (hereinafter referred to as a management number) assigned for each transfer range is set. In the head address 2212, the head address used to set the transfer range as a transfer parameter is set. In the ending address 2213, an ending address 2213 used to set the transfer range as a transfer parameter is set. In the transfer completion flag 2214, a flag (0: pre-transfer, 1: post-transfer) is set, which indicates whether or not the transfer of the control information in the transfer range from the first SM 144 to the second SM 144 has finished (is completed).

Note that, the second MP 122 determines each transfer range by dividing, with a predetermined method to be mentioned later, the storage region for the control information of the first SM 144, the control information being a target for transfer to the second SM 144 in the failure recovery processing S1800 in FIG. 18.

Returning to FIG. 20, the second MP 122 then acquires one transfer range (record) in which the transfer completion flag 2214 is set to “0: pre-transfer” among the transfer ranges (records) registered in the transfer range management table 2200 (S2013), and performs the setting for acquiring the number of updates of the control information, which is stored in the transfer range, during the transfer period of the transfer range (S2014).

Thereafter, the second MP 122 starts transferring the control information in the transfer range acquired in S2013, from the first SM 144 to the second SM 144 (S2015). Prior to the start of the transfer processing, the second MP 122 acquires an updated counter value of the above-mentioned transfer range from the first counter circuit 146 (S2016).

Here, during the above-mentioned transfer processing (S2015), when the first MP 122 receives the data input/output request from the host computer 3 (S1612 in FIG. 16) (S2017) and the control information of the first SM 144 in the above-mentioned transfer range is updated by the data input/output in response to the data input/output request (S1613 to S1618 in FIG. 16) (S2018), the update counter value for the relevant transfer range is updated by the counter circuit 146 (S2019).

When the transfer processing of the control information (S2015) finishes (S2020), the second MP 122 then acquires the update counter value in the transfer target region and compares the acquired update counter value with the update counter value acquired in S2016. As a result of the comparison, if the update counter value in the transfer target region is different from the update counter value acquired in S2016 the second SM 122 divides the transfer range acquired in S2013 (S2111 in FIG. 21), and reflects the result of the division in the transfer range management table 2200 (S2112). Thereafter, the second MP 122 re-executes the processing from S2013 in FIG. 20 according to the content of the transfer range management table 2200 after the division (S2113).

FIG. 23 shows an example of the transfer range management table 2200 after the transfer range in the transfer range management table 2200 shown in FIG. 22 has been divided. In this example, the transfer range (the record with the management number “1”) acquired in S2013 is divided into four transfer ranges with management numbers “1-1” to “1-4”.

Returning to FIG. 21, when the transfer processing of the transfer range acquired in S2013 finishes (S2114), the second MP 122 then determines whether or not the update counter value of the relevant transfer range is updated while the transfer processing of the transfer range acquired in S2013 is under process (S2113). If the update counter value has not been updated, “1: transferred” is set in the transfer completion flag 2214 of the relevant transfer range in the transfer range management table 2200 (S2115). On the other hand, if the update counter value has been updated during the above-mentioned period, the second MP 122 re-transfers the transfer range in its entirety (return to S2014).

In S2116, the second MP 122 determines whether or not the transfer range which has not been transferred yet remains in the transfer range management table 2200 (whether or not the transfer range (record) in which “0: not yet transferred” is set in the transfer completion flag 2214 remains). If the transfer range which has not been transferred yet is present (S2116: YES), the processing is repeated from S2013. On the other hand, if the transfer of all the transfer ranges has been completed (S2116: NO), the transfer of the control information ends (S2117).

As described above, when the control information stored in the transfer range (hereinafter referred to as a first transfer range) is updated while the control information is transferred, the storage apparatus 10 of the present embodiment performs again (reattempts) the data transfer of the first transfer range by setting a transfer range created by dividing the first transfer range (hereinafter referred to as a second transfer range) as a transfer parameter. Hence, the transfer range (the second transfer range) at the time of re-transferring is narrower than the transfer range at the time of previous execution (the first transfer range). This reduces the possibility of the control information in the transfer range being updated during the transfer of the control information as compared with the case of the previous transfer, so that the time needed to transfer the control information in the transfer range is reduced. Moreover, since the control information in the first transfer range is not prohibited from being updated during the transfer of the control information, there is no influence on the storage apparatus 10 by prohibiting control information from being updated.

Counter Circuit

The configuration and function of the above-mentioned counter circuit 146 is described below. The counter circuit 146 counts the number of updates performed on each of the storage regions (address ranges) partitioned in the SM 144 and retains the counted value (update counter value) for each partitioned storage region. Note that, as mentioned above, the counter circuit 146 is implemented as a hardware logic such as ASIC or FPGA. Thus, the counter circuit 146 is capable of counting the update counter value for each transfer range at high speed.

The counter circuit 146 keeps a table (hereinafter, referred to as an information management table 2400) for setting the operation of the counter circuit 146 concerned, setting the above-mentioned storage region range, managing the update counter value, and the like.

FIG. 24 shows an example of the information management table 2400. As shown in FIG. 24, the information management table 2400 includes at least one record containing items of head address 2411, ending address 2412, valid/invalid flag 2413, and update counter 2414. Among these items, the contents of the head address 2411, the ending address 2412, and the active/inactive flag 2413 can be set from outside (for example, from the processor 122 of the MPPK 12 (MP 122)) as needed.

Address values for specifying the storage region range of the SM 144 are set in the head address 2411 and the ending address 2412. Meanwhile, a flag set in the valid/invalid flag 2413 is for setting whether or not to count the number of updates in the storage region range (1: valid, 2: invalid).

The counter circuit 146 counts the number of updates performed in the above-mentioned storage region range while “1: valid” is set in the valid/invalid flag 2413. In contrast, the counter circuit 146 stops counting the number of updates in the above mentioned storage region range while “0: invalid” is set in the valid/invalid flag 2413. Note that, if the head address 2411 or the ending address 2412 is set from outside, “0: invalid” is set in the valid/invalid flag 2413 in advance. In the update counter 2414 of the information management table 2400, an update counter value counted for the above-mentioned storage region range is set.

When the transfer re-execution processing S1900 is under process, the head address 2212 of the transfer range management table 2200 is set in the head address 2411 and the ending address 2213 of the transfer range management table 2200 is set in the ending address 2412. Also, if the transfer range is divided (S2111 in FIG. 21), values corresponding to the transfer range after division are set in the head address 2212 and the ending address 2213. Moreover, if the transfer range is divided, the content of the information management table 2400 is updated. Thus, the range to be counted is also changed to the transfer range after division.

Transfer Range Setting

As methods of setting (dividing) the transfer range (storage region of the first SM 144 to be transferred with one transfer parameter) used to set the transfer range management table 2200 in S2012 of FIG. 20 include, for example, a method of equally dividing the entire storage region of the control information in the first SM 144 (hereinafter referred to as a zeroth setting method), a method of dividing the storage region of the control information in the first SM 144 according to the type of the control information stored in the first SM 144 (hereinafter referred to as a first setting method), and a method of determining a transfer range according to the update counter value for each given storage region defined in the first SM 144.

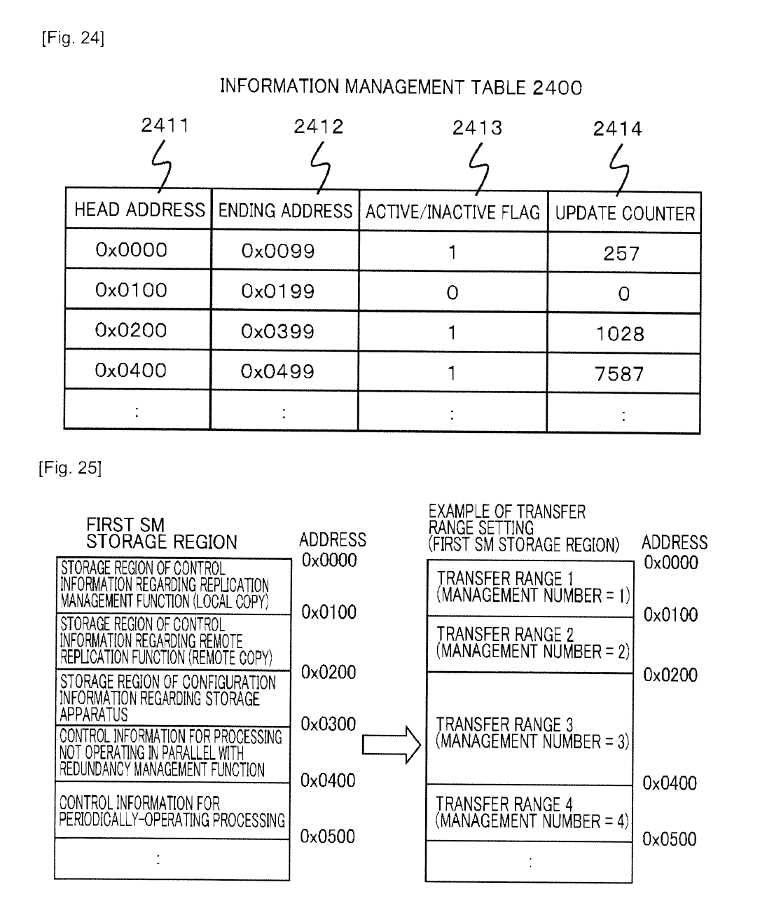

FIG. 25 shows an example of transfer ranges set according to the first setting method. As shown in FIG. 25, in this example, control information regarding the above-mentioned replication management function (local copy), control information regarding the above-mentioned remote replication function (remote copy), above-mentioned configuration information regarding the storage apparatus 10, control information for controlling the processing which does not operate in parallel with the redundancy management (multiplex management) function, control information for controlling periodically operating processing, and the like, are stored in given storage regions of the first SM 144 respectively allocated to these pieces of information.

As a specific example of the above-mentioned control information for controlling processing which does not operate in parallel with the redundancy management (multiplex management) function there is, such as, control information used for processing relating to maintenance of the storage apparatus 10, being such as processing performed along with increasing/decreasing devices of the storage drive 171. Further, as a specific example of the above-mentioned control information for controlling periodically operating processing, there is control information used for processing relating to failure monitoring of the storage apparatus 10, being such as processing for periodically monitoring for abnormalities in the hardware configuring the storage apparatus 10.

Here, the frequency of updating the control information stored in the SM 144 generally has a certain correlation with the types of the control information. For example, the control information regarding the replication management function (local copy) and the control information regarding the remote replication function (remote copy) are updated every time the data input/output request is processed. Thus, the frequency of updating the control information is high. In contrast, the configuration information of the storage apparatus 10 is hardly changed during normal operation of the storage apparatus 10 (except during maintenance or the like (increasing/decreasing devices, for example)). Thus, the update frequency is low.

Accordingly, when the transfer range is set according to the above-mentioned first setting method, for example, even if the transfer ranges whose update frequency is low are transferred all together, the transfer of the control information is less likely to be re-executed (S1919) and the setting frequency of the transfer parameter is also reduced. Thus, the control information can be transferred effectively and at high speed.

As shown in FIG. 25, in this example, the storage region (head address=“0x0000”, ending address=“0x0099”) of the control information regarding the replication management function (local copy) is set as a transfer range with management number 2211 of “1”, and the storage region (head address=“0x0100”, ending address=“0x0199”) of the control information for the remote replication function (remote copy) is set as a transfer range with management number 2211 of “2”. Moreover, the storage region (head address=“0x0200”, ending address=“0x0299”) of the configuration information of storage apparatus 10 and the storage region (head address=“0x0300”, ending address=“0x0399”) of the control information regarding the processing which does not operate in parallel with the redundancy management function are combined and then set as the transfer range with management number 2211 of “3”. Also, in the example of FIG. 25, the storage region (head address=“0x0400”, ending address=“0x0499”) of the control information for the periodically operating processing is set as the transfer range with management number 2211 of “4”.

Note that, if the updating frequencies of the pieces of adjacently stored control information are similar as in the case of the transfer range with management number 2211 of “3” in FIG. 25 (the transfer range 3 in FIG. 25), these pieces of control information may be included in one transfer range even if their types are different.

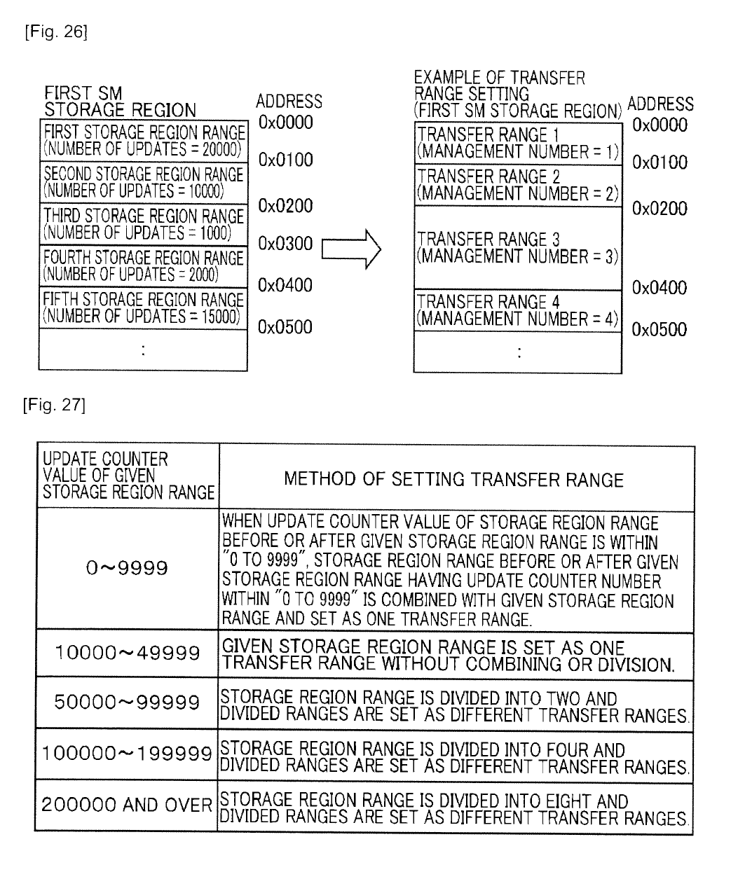

FIG. 26 is an example of a transfer range setting according to the second setting method. As mentioned above, in the second setting method, transfer ranges used to set the transfer range management table 2200 in S2012 are set according to the number of updates per unit time of each of the given storage region ranges partitioned in the first SM 144.

For example, a narrow transfer range is set for the storage region whose number of updates per unit time is large, so that the transfer of the control information from the first SM 144 to the second SM 144 (S1912) with one transfer parameter setting is completed in a short time and thus a possibility that the control information is updated during the transfer of the control information is reduced. Meanwhile, for example, a wide transfer range is set for a storage region range whose number of updates per unit time is small, so that an instruction to transfer a large storage region range is given with one transfer parameter setting.

The transfer range according to the second setting method is set by, for example, coupling or dividing the storage region (the range in which the number of updates is counted) partitioned in the first SM 144 according to a predetermined criteria. FIG. 27 shows an example of the criteria. In this example, for example, when the update counter value of a given storage region range falls within “0 to 9999”, it is checked whether or not the update counter number of a storage region range before or after the relevant storage region range is also within the range of “0 to 9999”. Then, the storage region range which is before or after the given storage region range and whose update counter number is within the range of “0 to 9999” is combined with the given storage region range and the combined range is used as one transfer range.

Meanwhile, when the update counter value of a given storage region range falls within “10000 to 49999”, the storage region range is set as one transfer range without coupling or division. Meanwhile, when the update counter value of a given storage region range falls within “50000 to 99999”, the storage region range is divided into two and the divided storage region ranges are respectively set as transfer ranges.

Meanwhile, when the update counter value of a given storage region range falls within “100000 to 199999”, the storage region range is divided into four and the divided storage region ranges are respectively set as transfer ranges. Meanwhile, when the update counter value of a given storage region range falls within “200000 or more”, the relevant storage region range is divided into eight and the divided storage region ranges are respectively set as transfer ranges.

In this way, in the second setting method, the transfer range management table 2200 is set according to the number of updates per unit time of the control information stored in each of the multiple storage regions partitioned in the first SM 144. Thus, the transfer range can be appropriately set according to the characteristic of the control information stored in each storage region.

Dynamic Change of Transfer Range

The content (transfer range) of the transfer range management table 2200 may be dynamically changed according to the number of updates set for each transfer range currently set in the transfer range management table 2200.

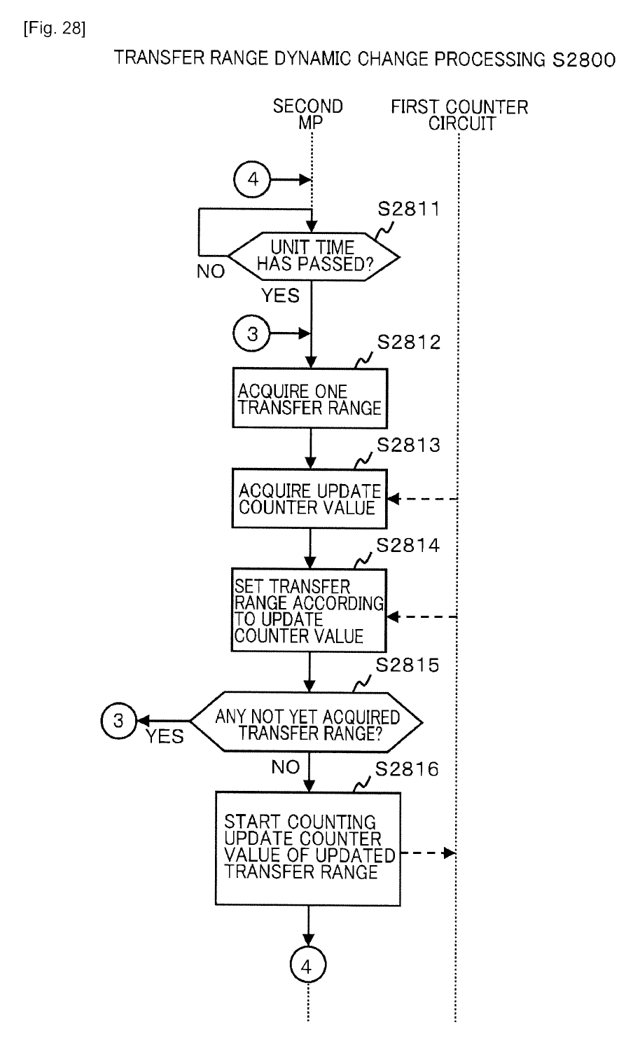

FIG. 28 is an example of a processing (hereinafter referred to as transfer range dynamic change processing S2800) to be performed in the storage apparatus 10 when the above-mentioned dynamic change is performed. In this processing, the second MP 122 acquires the number of updates of each transfer range set in the transfer range management table 2200 per unit time and dynamically changes the transfer range which is currently set in the transfer range management table 2200 according to the acquired number of updates.

As shown in FIG. 28, the second MP 122 monitors in real time whether or not a preset unit time (for example, one hour) has passed since the previous dynamic change has been made (S2811). When it is detected that a unit time has passed (S2811: YES), the second MP 122 acquires one of the transfer ranges set in the transfer range management table 2200 (S2812), and acquires the update counter value of the transfer range from the first counter circuit 146 (S2813).

Next, the second MP 122 sets a transfer range according to the acquired update counter value and reflects the set content in the transfer range management table 2200 (S2814). Note that, the above-mentioned setting is performed according to, for example, the criteria shown in FIG. 27. Note that, the second MP 122 acquires, from the first counter circuit 146, the update counter value (the number of updates since the previous change) of a transfer range before or after the relevant transfer range if needed at the time of setting the transfer range.

Then, the second MP 122 determines whether or not there is any transfer range which has not been acquired yet (not acquired at S2812) in the transfer range management table 2200 (S2815). If there is a transfer range not having been acquired yet (S2815: YES), the process returns to S2812 and a similar processing is performed again for another transfer range not having been acquired yet. In contrast, if there is no transfer range not having been acquired yet (S2815: NO), the first counter circuit 146 is set so as to start acquiring the update counter value of each transfer range in the transfer range management table 2200 (S2816). Thereafter, the process returns to S2811 and the second MP 122 waits for another unit time to pass.

Method of Dividing Transfer Range

As described in FIG. 20, when the control information of a certain transfer range of the first SM 144 is updated while the control information is transferred from the first SM 144 to the second SM 144 (S2021), the second MP 122 divides the transfer range and re transfers the control information. At this time, the information to be transferred is divided according to, for example, a difference between the update counter values of the relevant transfer range before and after the transfer processing (S2015) (an increment of the update counter value).

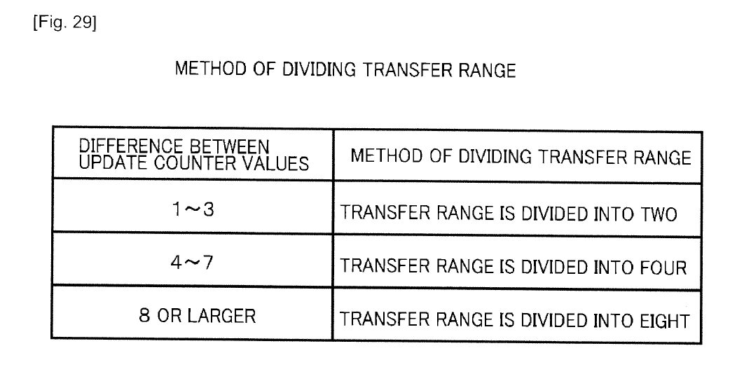

FIG. 29 shows an example of a method of dividing a transfer range. In this example, when a difference between the update counter values of the transfer range before and after the transfer processing (S2015) is “1 to 3”, the transfer range in which the update has been made is divided into two. When a difference between the update counter values is “4 to 5”, the transfer range in which update has been made is divided into four. When a difference between the update counter values is “8 or larger”, the transfer range in which update has been made is divided into eight.

As described above, the information to be transferred is divided according to a difference between the update counter values of the relevant transfer range before and after the transfer processing (S2015) (an increment of the update counter value). Thus, the transfer range can be properly divided according to how the control information is actually used.

Although an embodiment has been described hereinabove, the above embodiment is intended to facilitate the understating of the present invention and does not intend to restrict the scope of the present invention. The present invention can be modified or improved without departing from the spirit thereof and includes equivalents thereof.

For example, in the embodiment described above, failure recovery processing S1800, transfer re-execution processing S1900, and transfer range dynamic change processing S2800 are executed by the second MP 122. However, these processes may be executed by the first MP 122.

1. A storage apparatus comprising:
a processor that performs processing regarding data input/output to/from a storage device in response to a data input/output request transmitted from an external device;
a plurality of memories that store control information being information used when performing the processing for the data input/output request; and
a data transfer device that transfers data in a designated transfer range between the memories, wherein the storage apparatus
redundantly stores, the control information, in both a first one of the memories and a second one of the memories in response to a processing regarding the data input/output request,
makes the data transfer device transfer data by designating a first transfer range which is a storage region of the control information in the first memory, in order for the second memory to store the same control information as the control information stored in the first memory, and
makes the data transfer device transfer again data for the first transfer range, by designating a second transfer range which is created by dividing the first transfer range, when the control information stored in the first transfer range is updated during the data transfer.

2. The storage apparatus according to claim 1, further comprising a counter circuit that counts the number of updates performed in the control information in the first transfer range during the data transfer, wherein the storage apparatus
makes the data transfer device transfer again data for the first transfer range, by designating a second transfer range which is created by dividing, according to the number of updates, the first transfer range, when the control information stored in the first transfer range is updated during the data transfer.

3. The storage apparatus according to claim 1, further comprising a counter circuit that counts the number of updates per unit time of the control information stored in each of a plurality of storage regions partitioned in the storage region of the control information in the first memory, wherein the storage apparatus
creates the first transfer range according to the number of updates of the partitioned storage regions.

4. The storage apparatus according to claim 3, wherein the storage apparatus creates the first transfer range by combining or dividing adjacent partitioned storage regions according to the number of updates of the partitioned storage regions.

5. The storage apparatus according to claim 1, wherein the storage apparatus creates the first transfer range by dividing a storage region of the control information in the first memory according to a type of the control information.

6. The storage apparatus according to claim 1, wherein the storage apparatus creates the first transfer range by equally dividing a storage region of the control information in the first memory.

7. The storage apparatus according to claim 1, wherein the storage apparatus
performs a processing relating to a replicating management function storing, through the data input/output, a replica of data stored in a first logical volume in also a second logical volume, the first logical volume configured using a storage region of the storage device, the second logical volume configured using a storage region of the storage device, and
the control information is information that manages a difference between data stored in the first logical volume and data stored in the second logical volume, in the replication management function.

8. The storage apparatus according to claim 1, wherein the storage apparatus
performs a processing relating to a remote replication function storing, through the data input/output, a replica of data stored in a first logical volume in also a second logical volume through a different storage apparatus communicatively coupled to the storage apparatus, the first logical volume configured using a storage region of the storage device, the second logical volume configured using a storage region of another storage device coupled to the different storage apparatus, and
the control information is information that manages a difference between data stored in the first logical volume and data stored in the second logical volume, in the remote management function.

9. The storage apparatus according to claim 1, wherein the control information is information on a configuration of the storage apparatus used in the data input/output.

10. The storage apparatus according to claim 1, wherein the data transfer device is configured using a DMA (Direct Memory Access), and the storage apparatus
sets any one of the first transfer range and the second transfer range in the data transfer device as a transfer parameter of the DMA.

11. The storage apparatus according to claim 1, further comprising at least one front-end package including a circuit to communicate with the external device;
at least one back-end package including a circuit to communicate with the storage device;
at least one processor package provided with the processor and the data transfer device;
at least one main package including the memory and the cache memory; and
a counter circuit that counts the number of updates performed in the control information in the first transfer range during the data transfer, wherein the storage apparatus
makes the data transfer device transfer again data for the first transfer range, by designating a second transfer range which is created by dividing, according to the number of updates, the first transfer range, when the control information stored in the first transfer range is updated during the data transfer,
wherein the storage apparatus further includes
a counter circuit that counts the number of updates per unit time of the control information stored in each of a plurality of storage regions partitioned in the storage region of the control information in the first memory,
wherein the storage apparatus
creates the first transfer range according to the number of updates of the partitioned storage regions,
creates the first transfer range by combining or dividing adjacent partitioned storage regions according to the number of updates of the partitioned storage regions,
creates the first transfer range by dividing a storage region of the control information in the first memory according to a type of the control information,
creates the first transfer range by equally dividing a storage region of the control information in the first memory, and
performs a processing relating to a replicating management function storing, through the data input/output, a replica of data stored in a first logical volume in also a second logical volume, the first logical volume configured using a storage region of the storage device, the second logical volume configured using a storage region of the storage device, and
the control information is information that manages a difference between data stored in the first logical volume and data stored in the second logical volume, in the replication management function, the storage apparatus further
performs a processing relating to a remote replication function storing, through the data input/output, a replica of data stored in a first logical volume in also a second logical volume through a different storage apparatus communicatively coupled to the storage apparatus, the first logical volume configured using a storage region of the storage device, the second logical volume configured using a storage region of another storage device coupled to the different storage apparatus, and
the control information is information that manages a difference between data stored in the first logical volume and data stored in the second logical volume, in the remote management function,
the control information is information on a configuration of the storage apparatus used in the data input/output, and
the data transfer device is configured using a DMA (Direct Memory Access), and the storage apparatus further
sets any one of the first transfer range and the second transfer range in the data transfer device as a transfer parameter of the DMA.

12. A method of controlling a storage apparatus including
a processor configured to perform processing regarding data input/output to/from a storage device in response to a data input/output request transmitted from an external device;
a plurality of memories that store control information being information used when performing the processing for the data input/output request; and
a data transfer device that transfers data in a designated transfer range between the memories, the method comprising:
redundantly storing, by the storage apparatus, the control information, in both a first one of the memories and a second one of the memories in response to the processing regarding the data input/output request;
making, by the storage apparatus, the data transfer device transfer data by designating a first transfer range which is a storage region of the control information in the first memory, in order for the second memory to store the same control information as the control information stored in the first memory; and
making, by the storage apparatus, the data transfer device transfer again data for the first transfer range, by designating a second transfer range which is created by dividing the first transfer range, when the control information stored in the first transfer range is updated during the data transfer.

13. The method of controlling a storage apparatus according to claim 12, further comprising:
counting, by the storage apparatus, the number of updates performed in the control information in the first transfer range during the data transfer; and
making, by the storage apparatus, the data transfer device transfer again data for the first transfer range, by designating a second transfer range which is created by dividing, according to the number of updates, the first transfer range, when the control information stored in the first transfer range is updated during the data transfer.

14. The method of controlling a storage apparatus according to claim 12, further comprising:
counting, by the storage apparatus, the number of updates per unit time of the control information stored in each of a plurality of storage regions partitioned in the storage region of the control information in the first memory; and
creating, by the storage apparatus, the first transfer range according to the number of updates of the partitioned storage regions.

15. The method of controlling a storage apparatus according to claim 12, further comprising:
creating, by the storage apparatus, the first transfer range by dividing a storage region of the control information in the first memory according to a type of the control information.
